(19) United States
(12) Patent Application Publication
(10) Pub. No.: US 2006/0258308 A1
(43) Pub. Date: Nov. 16, 2006

(54) Electronic device for interleaving program segments and skipping program breaks from two radio/TV broadcasts

(76) Inventor: Charles Joseph Fassbender, Poway, CA (US)

Correspondence Address: Charles J. Fassbender, 15864 Bromegrass Court, Poway, CA, 92064, US

(21) Appl. No.: 11/125,708

(22) Filed: May 10, 2005

(51) Int. Cl. H04B 7/08

(52) U.S. Cl. 455/132

(57) ABSTRACT

An electronic device includes a memory module and a control module for the memory module. The control module repeatedly—a) stores samples of a first received radio/TV broadcast within the memory module in a first sequence, b) stores samples of a second received radio/TV broadcast within the memory module in a second sequence, and c) sends the stored samples from the memory module to an output port in a third sequence. The third sequence consists essentially of selectable spaced-apart segments of the first sequence of samples interleaved with selectable spaced-apart segments of the second sequence of samples.

### BACKGROUND OF THE INVENTION

The present invention relates to the technical field of receiving radio or television broadcasts.

By a radio broadcast is herein meant the transmission of sound to the public via radiated electrical signals. Conventionally, several transmitting stations radiate their respective radio broadcasts at the same time in separate frequency bands. Then a radio selectively receives one of the broadcasts in its particular frequency band and regenerates sound from the received broadcast.

Similarly, by a television broadcast is herein meant the transmission of sound and pictures to the public via electrical signals that are radiated or sent in a cable. Conventionally, several transmitting stations radiate their respective television broadcasts at the same time in separate frequency bands called channels. Also conventionally, a single satellite radiates several television broadcasts at the same time in separate channels, or a single transmitting station sends several television broadcasts at the same time in separate channels over a co-axial cable or an optical fiber cable. In each of the above cases, a television selectively receives one of the broadcasts in its particular channel and regenerates sound and pictures from the received broadcast.

Typically, each radio broadcast and each television broadcast is comprised of a series of “programs”, where each program is transmitted in multiple “program segments” that are spaced-apart in time by respective “program breaks”. By a program break is herein meant any commercial, traffic report, weather report, news update, announcer chatter, or other similar items.

One particular problem for a person who listens to a radio program, or watches a television program, is that the program breaks waste a huge amount of the person's time. For example, during one randomly chosen hour of the Rush Limbaugh radio program, the time duration of the program breaks (rounded to the nearest minute) were eight minutes, four minutes, four minutes, five minutes, and five minutes. Between these program breaks, the time duration of the program segments (rounded to the nearest minute) were eleven minutes, seven minutes, ten minutes, and five minutes. Thus, for the listener, the above program breaks waste a total of twenty-seven minutes out of one hour.

As another example, during one randomly chosen hour of the Hannity & Colmes news program on Fox television, the time duration of the program breaks (rounded to the nearest minute) were one minute, four minutes, four minutes, five minutes, three minutes, four minutes, and three minutes. Between these program breaks, the time duration of the program segments (rounded to the nearest minute) were eight minutes, four minutes, six minutes, six minutes, five minutes, six minutes, and one minute. Thus, for the viewer, the above program breaks waste a total of twenty-four minutes out of one hour.

Not only do these program breaks waste a person's time, they also are annoying. For example, announcers during a program break often just ramble on-and-on about trivia. Also, frequently occurring breaks for weather and traffic can be so repetitious that they sound like a broken record. Further, advertisements usually occur in a burst where one product after another is attempted to be sold.

To fully appreciate the magnitude of the above problems, consider the number of people who are affected. A conservative estimate is that at least one hundred million people in just the U.S. listen to the radio and/or watch TV for two hours a day. Program breaks occur in about half of those two hours. Thus, in just the U.S., at least one hundred million man-hours per day are wasted. The total number of people, worldwide, who are affected each day by the above wasted time and annoyance problems is probably at least one billion!

According, one primary object of the present invention is to provide a novel electronic device by which the above wasted time and annoyance problems are completely overcome.

### BRIEF SUMMARY OF THE INVENTION

The present invention is an electronic device which is comprised of a memory module and a control module that is coupled to the memory module. The control module repeatedly performs three operations on the memory module at a rate of thousands of times per second. These operations are—a) store samples of a first received radio/TV broadcast within the memory module in a first sequence, b) store samples of a second received radio/TV broadcast within the memory module in a second sequence, and c) selectively send the stored samples from the memory module to an output port in a third sequence.

The third sequence consists essentially of selectable spaced-apart segments of the samples in the first sequence that are interleaved with selectable spaced-apart segments of the samples in the second sequence. An operator interface is included in the control module for receiving commands from an operator which select the spaced-apart segments of the samples in the first and second sequences that are sent from the memory module to the output port in the third sequence.

Two of the above commands which the operator interface receives are a SWITCH command and a SKIP command. The control module responds to the SWITCH command by sending samples of the first sequence from the memory module to the output port in the third sequence if samples of the second sequence are being sent when the SWITCH command occurs, and vice-versa. Also, the control module generates addresses which read samples from the memory module for the third sequence such that the addresses change at a predetermined rate when the SKIP command is absent, and otherwise changes at a substantially faster rate when the SKIP command is present.

The SWITCH and SKIP commands preferably are sent from two pushbuttons that are coupled by conductors from a control panel, or by wireless transmission from a remote control handset, to the operator interface. By using just one finger to operate the SWITCH and SKIP pushbuttons, the samples from all of the program segments in two simultaneous radio/TV broadcasts can be interleaved and sent from the memory module to the output port while the samples from all of the program breaks in those two broadcasts are skipped.

The interleaving and skipping of samples on the output port occurs continuously and in real-time while samples of the two received radio/TV broadcasts are being stored in the memory module. From these samples on the output port, the voice/voice-and-picture in the corresponding program segments of the two received radio/TV broadcasts are regenerated.

In one preferred embodiment that works with radio broadcasts, the memory module is comprised of just four dynamic memory chips and the control module is comprised of a single state machine in just one additional chip.

In another preferred embodiment that works with television broadcasts, the memory module is comprised of two discs and the control module is comprised of two state machines that operate concurrently.

### BRIEF DESCRIPTION OF THE DRAWINGS

FIG. 1 shows the exterior of an electronic device which is one preferred embodiment of the present invention that works with radio broadcasts.

FIG. 2 shows one preferred internal circuit for the FIG. 1 embodiment of the present invention.

FIG. 3 is a timing diagram which illustrates the operation of the circuit in FIG. 2.

FIG. 4 shows various steps which are sequentially performed by a control circuit module in FIG. 2.

FIG. 5A shows a set of equations which determine a suitable time period for repeatedly performing steps S2-S8 in FIG. 4.

FIG. 5B shows a set of equations which determine a suitable storage capacity for each of two DRAM's that are in FIG. 2.

FIG. 5C shows a set of equations which determine how long the samples of the program segments in FIG. 3 are temporarily stored in the DRAM's in FIG. 2.

FIG. 5D shows a set of equations which determined how many refresh commands need to be issued in step S5 of FIG. 4.

FIG. 6 shows one preferred structure for the control circuit module in FIG. 2.

FIG. 7A shows several instructions that are executed by the control circuit module in FIG. 2 in order to perform step S1 in FIG. 4.

FIG. 7B shows several instructions that are executed by the control circuit module in FIG. 2 in order to perform steps S2 and S3 in FIG. 4.

FIG. 7C shows several instructions that are executed by the control circuit module in FIG. 2 in order to perform steps S4 and S5 in FIG. 4.

FIG. 7D shows several instructions that are executed by the control circuit module in FIG. 2 in order to perform steps S6, S7 and S8 in FIG. 4.

FIG. 7E shows several instructions that are executed by the control circuit module in FIG. 2 in order to skip forward during step S6 in FIG. 4.

FIG. 7F shows several instructions that are executed by the control circuit module in FIG. 2 in order to skip backward during step S6 in FIG. 4.

FIG. 8 shows—a) the exterior of an electronic device which is a second preferred embodiment of the present invention that works with television broadcasts, and b) a component video TV receiver plus a remote control handset that are used in conjunction with this second preferred embodiment.

FIG. 9 shows one preferred internal circuit for the FIG. 8 embodiment of the present invention.

FIG. 10A shows various steps which are sequentially preformed by a first state machine in FIG. 9.

FIG. 10B shows various steps which are sequentially performed by a second state machine in FIG. 9.

FIG. 11 shows one preferred structure for the first state machine in FIG. 9.

FIG. 12 shows a set of equations which determine a suitable storage capacity for each of two discs that are in FIG. 9.

FIG. 13 shows a set of equations which determine a suitable storage capacity for each of two write buffers that are in FIG. 9.

FIG. 14 shows a set of equations which determine a suitable storage capacity for a read buffer that is in FIG. 9.

FIG. 15 shows a set of equations which determined the economic feasibility of constructing the entire circuit of FIG. 9.

### DETAILED DESCRIPTION

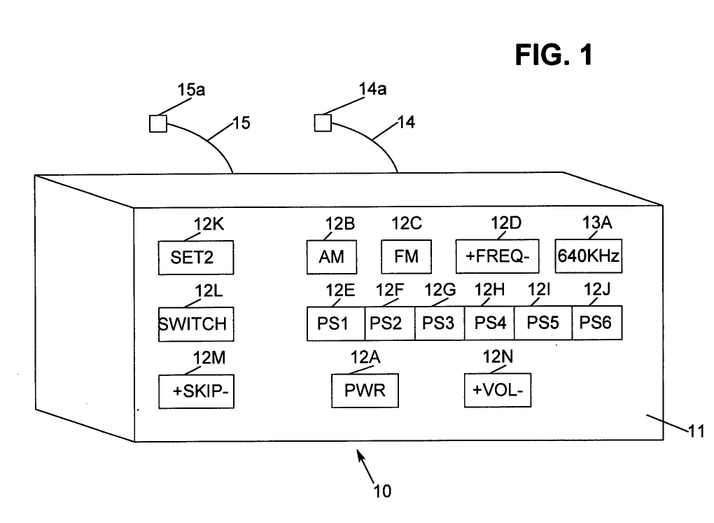

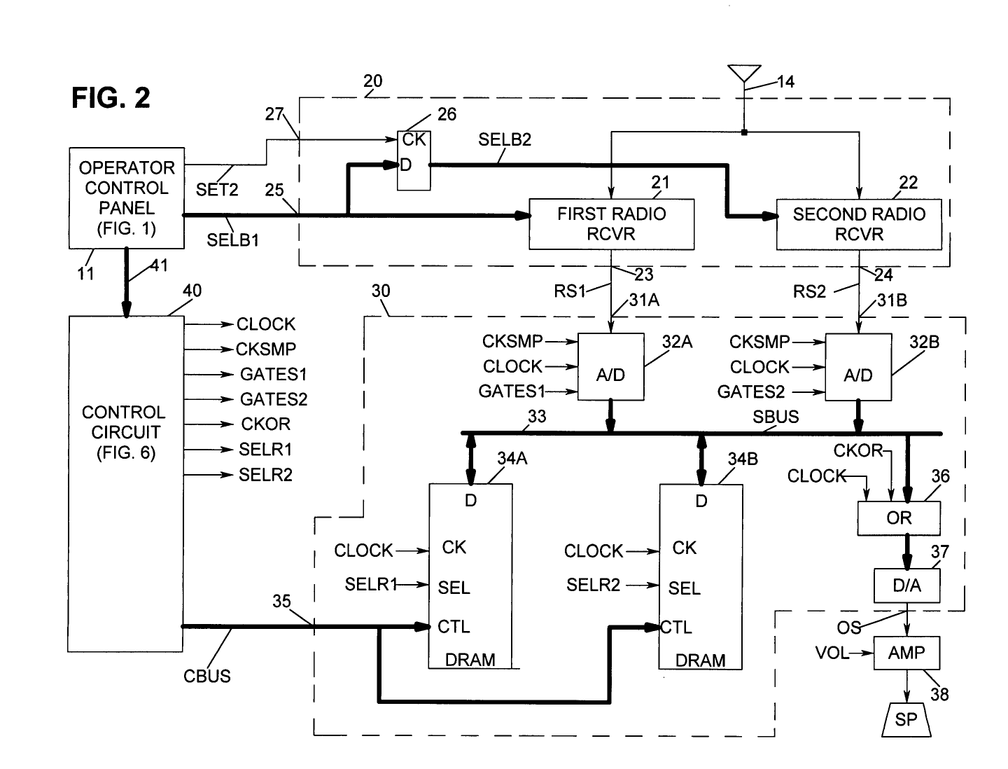

In FIG. 1, an electronic device 10 is shown which is one preferred embodiment of the present invention. This electronic device 10 receives first and second radio broadcasts simultaneously in separate frequency bands. Also, while both of the radio broadcasts are being received, the electronic device 10 temporarily stores both of the received broadcasts. Further, concurrently with the above operations, the electronic device 10 sends spaced-apart program segments from both of the temporarily stored radio broadcasts to a speaker in an interleaved output sequence. All program breaks in the temporarily stored radio broadcasts can be skipped in the interleaved output sequence by commands from an operator.

The electronic device 10 has an operator control panel 11 which includes several pushbuttons 12A-12N and one numerical display 13A. Each pushbutton 12A-12N is named, as shown in FIG. 1, to indicate the pushbuttons' function. These functions are described below in TABLE 1.

TABLE 1

| PUSHBUTTON | FUNCTION |
|---|---|
| 12A (PWR) | This pushbutton is pushed |
| | once to turn power on in |
| | the electronic device 10, |
| | and pushed again to turn |
| | power off in the electronic |
| | device. |
| 12B (AM) | This pushbutton is pushed |
| | to select a broadcast in |
| | the AM radio frequency |
| | spectrum. |
| 12C (FM) | This pushbutton is pushed |
| | to select a broadcast in |
| | the FM radio frequency |
| | spectrum. |
| 12D (+FREQ−) | This pushbutton is pushed |
| | on the “+” side to increase |
| | the carrier frequency of |
| | the broadcast that is |
| | currently being received as |
| | the first broadcast, and |
| | pushed on the “−” side to |
| | decrease that carrier |
| | frequency. The |
| | increase/decrease in |
| | carrier frequency occurs as |
| | long as pushbutton 12D is |
| | pushed. |
| 12E (PS1) | This pushbutton is pushed |
| | to receive a broadcast at a |
| | preset carrier frequency. |
| | The presetting is achieved |
| | by first using one or more |
| | of the pushbuttons 12B-12D |
| | to select a carrier |
| | frequency in the AM or FM |
| | frequency spectrum, and |
| | then holding pushbutton 12E |
| | down for a prolonged |
| | period, such as five |
| | seconds. |
| 12F-12J (PS2-PS6).. | Each of these pushbuttons |
| | perform the same function |
| | as pushbutton 12E (PS1). |
| 12K (SET2) | This pushbutton is pushed |
| | to set the carrier |
| | frequency that was last |
| | selected via the |
| | pushbuttons 12B-12J as the |
| | carrier for the second |
| | broadcast that is received. |
| 12L (SWITCH) | This pushbutton is pushed |
| | to start playing the |
| | temporarily stored second |
| | broadcast if the |
| | temporarily stored first |
| | broadcast is currently |
| | being played, and vice- |
| | versa. |
| 12M (+SKIP−) | This pushbutton is pushed |
| | to skip over program breaks |
| | in the temporarily stored |
| | broadcast that is currently |
| | being played. To skip |
| | forward, this pushbutton is |
| | pushed on “+” side. To |
| | skip backward, this |
| | pushbutton is pushed on the |
| | “−” side. The skipping |
| | occurs as long as the |
| | pushbutton is pushed. |
| 12N (+VOL−) | This pushbutton is pushed |
| | on the “+” side to increase |
| | the volume of the |
| | temporarily stored |
| | broadcast that is currently |
| | being played, and pushed on |
| | the “−” side to decrease |
| | that volume. |

Using the operator control panel 11, the second radio broadcast in initially selected and then the first radio broadcast is selected. The second radio broadcast is selected by pressing one or more of the pushbuttons 12B-12J followed by pressing the SET2 pushbutton 12K. Thereafter, the first radio broadcast is selected by again pressing one or more of the pushbuttons 12B-12J. The display 13A identifies the carrier frequency of the broadcast that is currently selected by the pushbuttons 12B-12J.

Suppose for example, that the second radio broadcast which is to be received is an AM broadcast with a carrier of 640 KHz, and the first radio broadcast which is to be received is an FM broadcast with a carrier of 96.5 MHz. To select the second radio broadcast, the AM pushbutton 12B is pushed; then the +FREQ− pushbutton 12D is pushed on the “+” or “−” side until 640 KHz is shown in the display 13A; and then the SET2 pushbutton 12K is pushed. Thereafter, to select the first radio broadcast, the FM pushbutton 12C is pushed; then the +FREQ− pushbutton 12D is pushed on the “+” or “−” side until 96.5 MHz is shown in the display 13A.

The carrier frequency which is currently shown in the display 13A is stored by pushing anyone of the preset pushbuttons 12E-12J for a period of at least five seconds. Thereafter, to receive the second broadcast at one stored frequency, the corresponding preset pushbutton 12E-12J is pushed followed by the SET2 pushbutton 12K. Then to receive the first broadcast at another stored frequency, only the corresponding preset pushbutton 12E-12J is pushed.

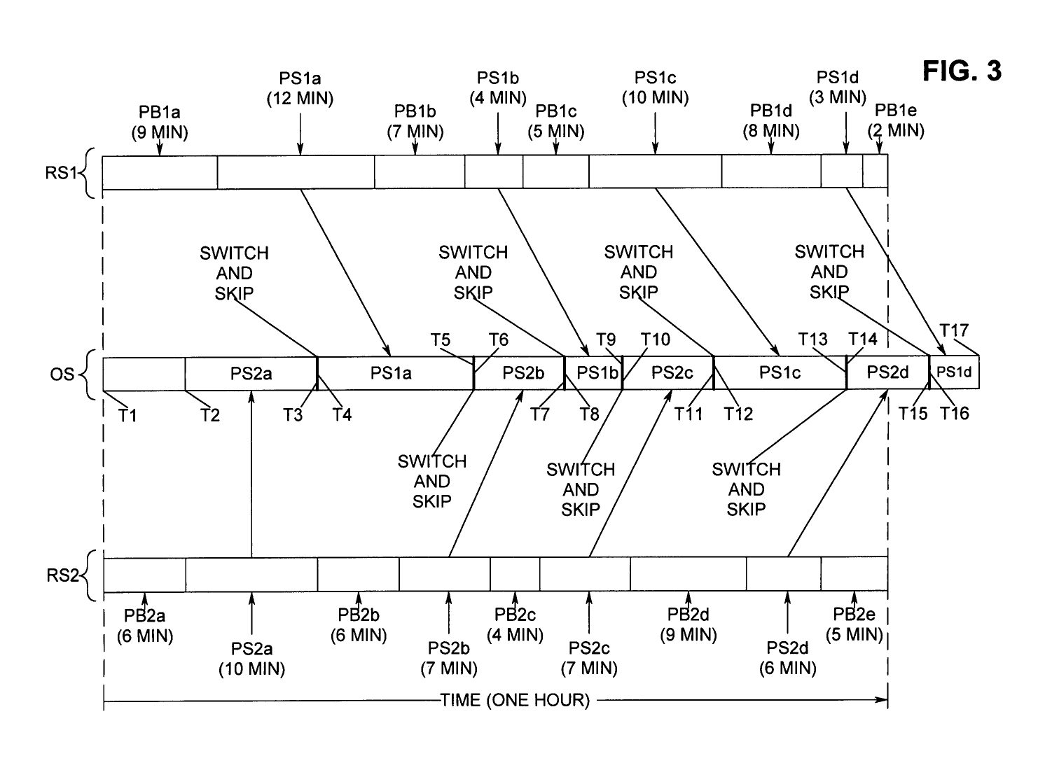

Both the first and the second radio broadcast, which are selected by the pushbuttons 12B-12K as described above, are received simultaneously by the electronic device 10. Also, both of the received broadcasts are temporarily stored in the electronic device 10. Further, while the receiving and storing operations are occurring, the electronic device 10 sends spaced-apart segments of the two temporarily stored broadcasts to a speaker in an interleaved output sequence which is controlled by the SWITCH and +SKIP− pushbuttons 12L and 12M. The use of these SWITCH and +SKIP− pushbuttons to generate the interleaved output sequence is described in detail later in conjunction with FIG. 3.

Lastly, in FIG. 1, the electronic device 10 is shown as having a power cable 14 which carries electrical power to the electronic device, and an antenna cable 15 which carries the radio broadcasts that are selectively received. Cable 14 has a terminal 14a for connecting to a power source, and cable 15 has a terminal 15a for connecting to a radio antenna.

Next, with reference to FIG. 2, a preferred embodiment of the circuitry which is in the electronic device 10 of FIG. 1 will be described. This circuitry includes three modules which are identified in FIG. 2 by reference numerals 20, 30, and 40.

Module 20 is a dual broadcast receiving circuit which includes a first radio receiver 21 and a second radio receiver 22. The first radio receiver 21 generates first receiver signals RS1 on an output 23; and simultaneously, the second radio receiver 22 generates second receiver signals RS2 on an output 24.

The signals RS1 and RS2 respectively represent two different radio broadcasts that are received at the same time. In one preferred embodiment, the signals RS1 and RS2 are analog signals which will reproduce the sound in the two received radio broadcasts if they are sent through separate audio amplifiers to respective speakers.

Selection signals SELB1 select the first radio broadcast that is received, and they are sent to the first radio receiver 21 on inputs 25. Selection signals SELB2 select the second radio broadcast that is received, and they are sent to the second radio receiver 22 from a register 26. Register 26 has a control input 27 that receives a signal SET2. When pushbutton 12K is pushed, the SET2 signal is a “1” and that causes register 26 to store the SEL1 signals as the SEL2 signals.

Module 30 in FIG. 2 is a memory circuit that has inputs 31A and 31B to which the receiver signals RS1 and RS2 respectively are sent. From the inputs 31A, the signals RS1 are sent to an A/D (analog-to-digital) converter 32A. From the inputs 31B, the signals RS2 are sent to an A/D converter 32B.

Both of the A/D converters 32A and 32B also receive a digital control signal CKSMP and a clock signal CLOCK. If CKSMP is a “1” when the CLOCK makes a “0” to “1” transition, the A/D converters 32A and 32B respectively take one sample of the analog RS1 and RS2 signals. Then, each A/D converter 32A and 32B converts its analog sample to a digital sample.

Each of the A/D converters 32A and 32B has an output that is coupled to an SBUS (sample bus) 33. Also, the A/D converter 32A has an input which receives a digital control signal GATES1, and the A/D converter 32B has an input which receives a digital control signal GATES2. The A/D converter 32A sends its digital sample to the SBUS 33 when the signal GATES1 is a “1”, and the A/D converter 32B sends its digital sample to the SBUS 33 when the signal GATES2 is “1”.

The SBUS 33 is coupled as shown in FIG. 2 to a first DRAM (dynamic random access memory) 34A and a second DRAM 34B. Each of these DRAM's has data inputs D, control inputs CTL, a select input SEL, and a clock input CK. Various digital control signals (such as write control signals and read control signals) are sent to the CTL inputs on a CBUS (control bus) 35.

The DRAM 34B temporarily stores digital samples that are sent on the SBUS 33 from the A/D converter 32A. To store one sample in the DRAM 34A, a digital signal SELR1 is sent as a “1” to the SEL input of the DRAM 34A while CLOCK and write control signals are respectively sent to the CK and CTL inputs.

Similarly, the DRAM 34B temporarily stores digital samples that are sent on the SBUS 33 from the A/D converter 32B. To store one sample in the DRAM 34B, a digital signal SELR2 is sent as a “1” to the SEL input on the DRAM 34B while CLOCK and write control signals are respectively sent to the CK and CTL inputs.

From the DRAMS 34A and 34B, the stored samples are selectively sent onto the SBUS 33 to an output register 36. One sample from the SBUS 33 is loaded into the output register 36 if a digital signal CKOR is a “1” when the CLOCK signal makes a “0” to “1” transition. All of the samples that are loaded into the output register 36 are sent to a D/A (digital-to-analog) converter 37, and output signals OS from the D/A converter 37 are sent to an output port 38. Any sound that is carried by the output signals OS is regenerated and “played” by sending the output signals OS through an audio amplifier AMP to a speaker SP.

To send one sample from the DRAM 34A to the SBUS 33, the signal SELR1 is sent as a “1” to the SEL input on the DRAM 34A while the CLOCK and read control signals are respectively sent to the CK and CTL inputs. Similarly, to send one sample from the DRAM 34B to the SBUS 33, the signal SELR2 is sent as a “1” to the SEL input of the DRAM 34B while the CLOCK and read control signals are respectively sent to the CK and CTL inputs.

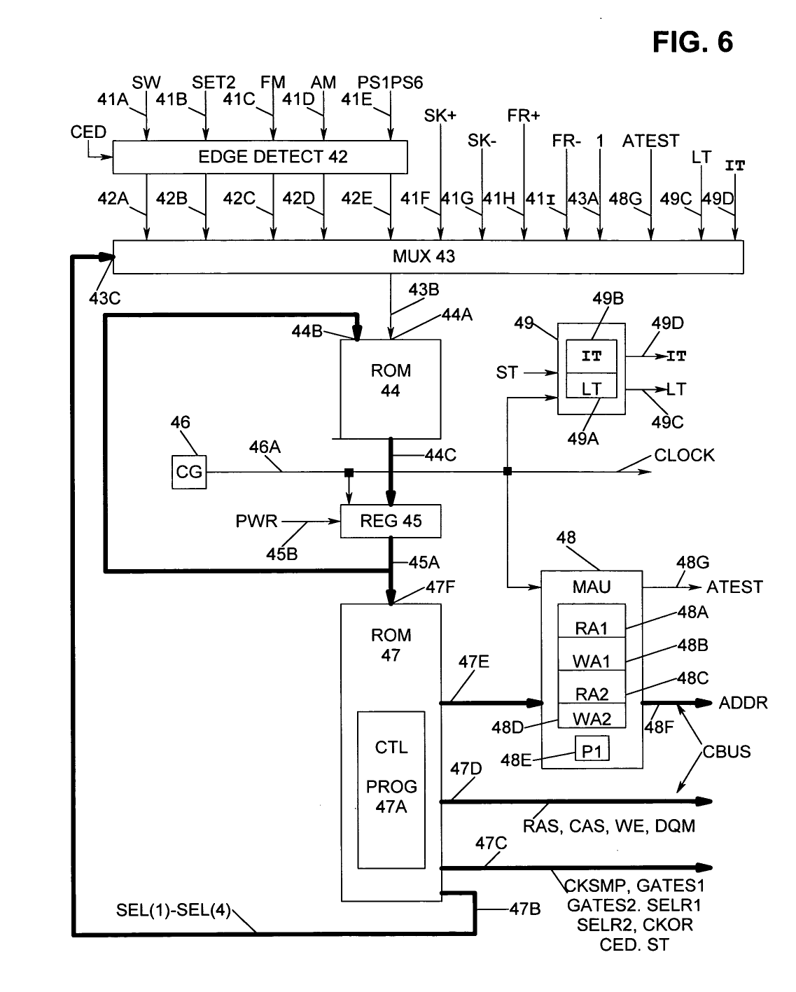

Module 40 in FIG. 2 is a control circuit which generates all of the signals CKSMP, GATES1, GATES2, CKOR, SELR1, SELR2, and CLOCK that are sent to the memory circuit 30. Also, the control circuit 40 generates all of the control signals that are sent on the CBUS 35 to the DRAMS 34A and 34B. One preferred structure for the control circuit 40 is shown in FIG. 6, which is described later.

Also, shown in FIG. 2 is the operator control panel 11 which includes all of the pushbuttons 12A-12M that are shown in FIG. 1 and were previously described. Respective signals from each of the pushbuttons 12A-12M are sent on a set of conductors 41 to the control circuit 40, and those signals direct the operation of the control circuit. Also, the selection signals SELB1 and SET2 are generated by the pushbuttons 12A-12M in the operator control panel 11 and sent to the inputs 25 and 27 of the dual broadcast receiving circuit 20.

Next, with reference to FIG. 3, a timing diagram will be described which illustrates the operation of all of the modules 20, 30, 40, and 50 in FIG. 2. The RS1 signals in FIG. 3 show one example of the receiver signals that are generated by the first radio receiver 21 on its outputs 23. Similarly, the RS2 signals in FIG. 3 show one example of the receiver signals that are generated by the second radio receiver on its outputs 24.

The OS signals in FIG. 3 are the output signals that are generated by the memory circuit 30 on its output port 38. These output signals OS are comprised of selected segments of the RS1 signals and selected segments of the RS2 signals. In the output signals OS, the selected segments of the RS1 signals are spaced-apart and interleaved with the selected segments of the RS2 signals.

The RS1 signals in FIG. 3 consist of program segments PS1a-PS1d and program breaks PB1a-PB1e. These RS1 signals begin with the program break PB1a which lasts for nine minutes. The program break PB1a is followed by the program segment PS1a which last for twelve minutes. The program segment PS1a is followed by the program break PB1b which last for seven minutes, etc. The entire sequence of the program segments PS1a-PS1d and program breaks PB1a-PB1e, and their time duration, is shown in FIG. 3.

Similarly, the RS2 signals in FIG. 3 consist of program segments PS2a-PS2d and program breaks PB2a-PB2e. These RS2 signals begin with the program break PB2a which lasts for six minutes. The program break PB2a is followed by the program segment PS2a which last for ten minutes. The program segment PS2a is followed by the program break PB2b which lasts for six minutes, etc. Here again, the entire sequence of the program segments PS2a and PS2d and program breaks PB2a and PB2e is shown in FIG. 3.

The output signals OS in FIG. 3 begin with program segment PS2a since it is the first program segment that is received by the two radio receivers 21 and 22. To detect which radio receiver 21 or 22 receives a program segment first, the operator repeatedly pushes the SWITCH pushbutton 12L and listens to the speaker SP. This occurs from time T1 to time T2 in FIG. 3.

Each time the SWITCH pushbutton 12L is pushed, samples are sent from a different one of the DRAMS 34A or 34B to the output register 36. The operator stops pushing the SWITCH pushbutton 12L as soon as he hears a program segment start to play from the speaker SP. This occurs at time T2 in FIG. 3.

While program segment PS2a is playing from the speaker SP, the operator simply listens and doesn't push any of the pushbuttons 12A-12M. This occurs from time T2 to time T3 in FIG. 3. Then, when the operator hears the program break PB2b start to play, he pushes the SWITCH pushbutton 12L.

In response to the SWITCH pushbutton 12L, samples of the program break PB2b stop being sent from the DRAM 34B to the output register 36, and samples of the program break PB1a start being sent from the DRAM 34A to the output register 36. To bypass this program break PB1a, the operator uses the SKIP pushbutton 12M. As long as the SKIP pushbutton 12M is pushed, samples of the program break PB1a are sent from the DRAM 34A to the output register 36 in a sequence where most of the samples are skipped.

In one preferred embodiment, for each sample of PB1a that is sent from the DRAM 34A to the output register 36, the next sixty samples in the DRAM 34A are skipped. This reduces the time that it takes to send the program break PB1a to the output register 36 by a factor of sixty. Thus, the nine-minute long program break PB1a can be skipped in only nine seconds.

To detect when the end of the program break PB1a is being sent to the output register 36, the operator repeatedly pushes the SKIP pushbutton 12M for about one second and listen for a few seconds. Then when the operator hears the end of the program break PB1a, the operator stops pushing any of the pushbuttons 12A-12M. This occurs at time T4 in FIG. 3. Then the operator simply listens while the next program segment PS1a is sent from the DRAM 34A to the output register 36. This occurs from time T4 to time T5.

At time T5 in FIG. 3, the operator hears the program break PB1b start to play. When this occurs, the operator pushes the SWITCH pushbutton 12L. In response to the SWITCH pushbutton 12L, samples of the program break PB1b stop being sent from the DRAM 34A to the output register 36, and samples of the program break PB2b start being sent from the DRAM 34B to the output register 36.

To bypass this program break PB2B, the operator again repeatedly pushes the SKIP pushbutton 12M for about one second and listens for a few seconds. When the operator hears the end of the program break PB2b, the operator stops pushing any of the pushbuttons 12A-12M. This occurs at time T6 in FIG. 3. Then the operator simply listens while the next program segment PS2b is sent from the DRAM 34B to the output register 36. This occurs from time T6 to time T7.

By continuing to use the SWITCH pushbutton 12L and the SKIP pushbutton 12M in the above described manner, the operator skips all of the remaining program breaks and hears all of the remaining program segments. In FIG. 3, these remaining program breaks are skipped at time intervals T7-T8, T9-T10, T11-T12, T13-T14, and T15-T16. Also in FIG. 3, the remaining program segments are heard at time intervals T8-T9, T10-T11, T12-T13, T14-T15, and T16-T17.

In FIG. 3, the RS1 signals from the first radio receiver 21 are shown for a time period of one hour; and in that hour, the program segments PS1a-PS1d last for a total of twenty-nine minutes. Thus, if the RS1 signals are sent through an amplifier to a speaker, anyone who listens to the resulting sound will hear only thirty-one minutes of program segments and will waste thirty-one minutes of one hour.

Similarly in FIG. 3, the RS2 signals from the second radio receiver are shown for a time period of one hour; and in that hour, the program segments RS2a-RS2d last for a total of thirty minutes. Thus, if the RS2 signals are sent through an amplifier to a speaker, anyone who listens to the resulting sound will hear only thirty minutes of program segments and will waste thirty minutes of one hour.

By comparison, from time T2 to time T17 in FIG. 3, the output signals OS contain fifty-nine minutes (twenty-nine plus thirty) of the program segments from both the RS1 signals and the RS2 signals. The time interval T2-T17 lasts just slightly longer than fifty-nine minutes because skipping each program break takes a few seconds.

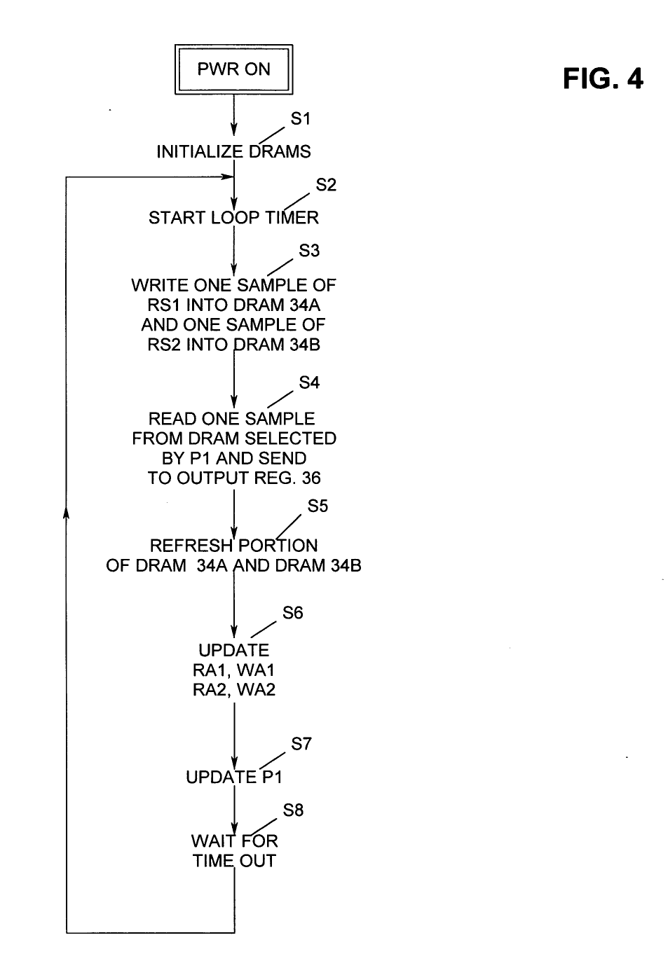

Next, with reference to FIG. 4, additional details regarding the control circuit 40 of FIG. 2 will be described. In FIG. 4, eight steps S1-S8 are shown, and all of those steps are performed by the control circuit 40.

Step S1 is performed immediately after electrical power is turned-on via the PWR pushbutton 12A. In step S1, the control circuit 40 sends several control signals to the memory circuit 40, and those control signals initialize the DRAMS 34A and 34B.

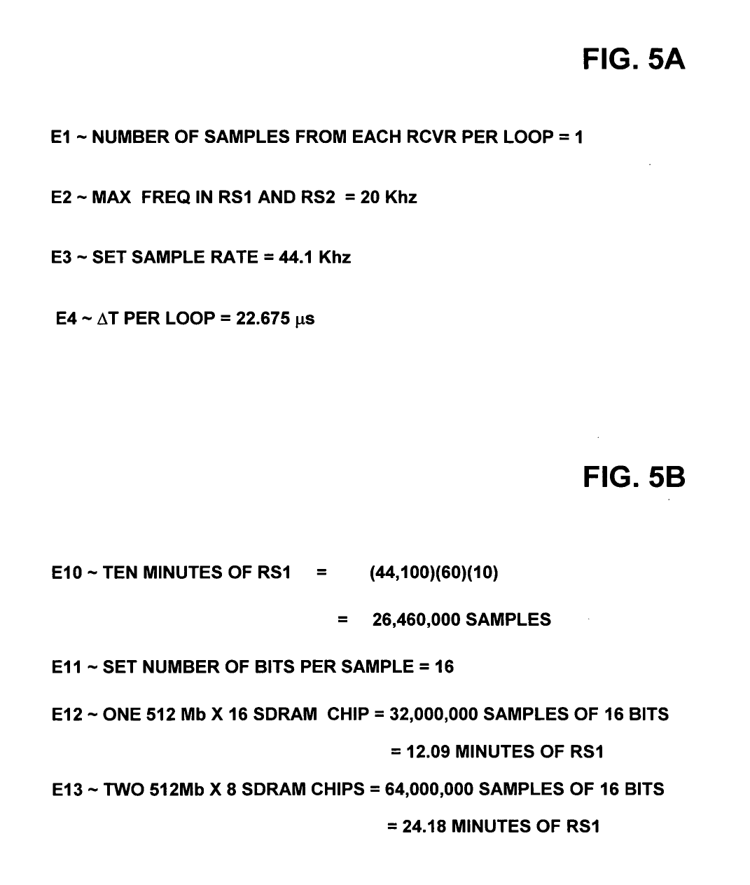

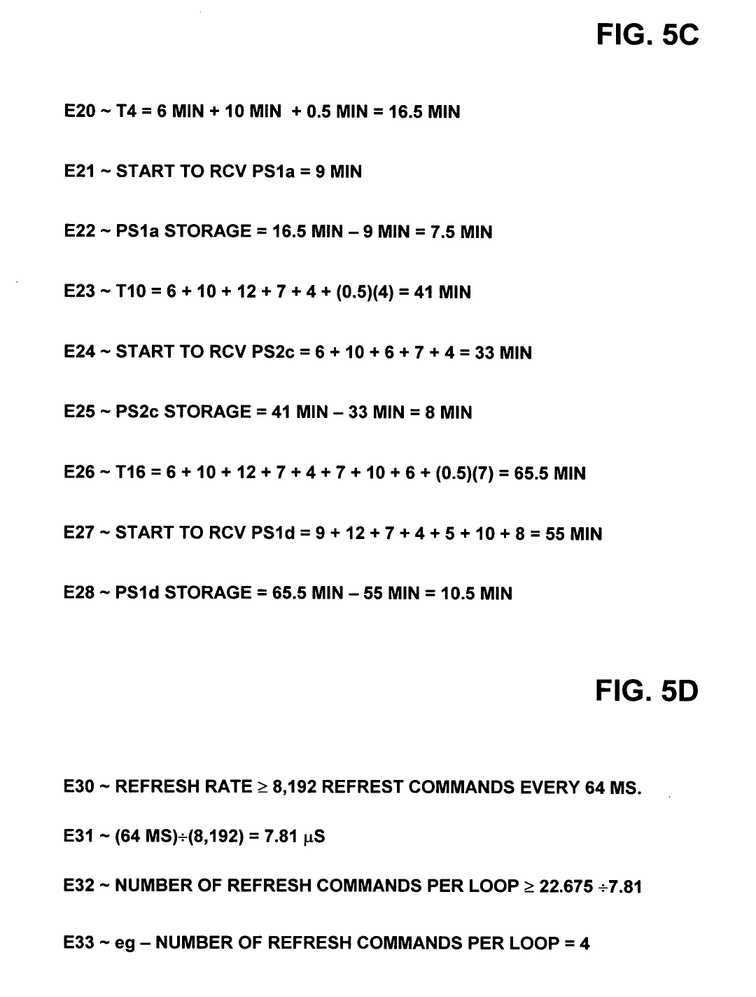

After step S1, the control circuit 40 cyclically performs the remaining steps S2-S8 in a loop. The time period for each cycle in the loop is fixed and set by a loop timer within the control circuit 40. The loop timer is started in step S2. A calculation of the time period for this loop timer is made in FIG. 5A, which is described later.

In step S3, the control circuit 40 writes one sample of the first radio receiver signals RS1 into the DRAM 34A, and the control circuit 40 also writes one sample of the second radio receiver signals RS2 into the DRAM 34B. A calculation is made in FIG. 5B which indicates how many samples from the signals RS1 and RS2 can be stored in a single DRAM integrated circuit chip. Another calculation is made in FIG. 5C which indicates how many chips are needed in the DRAMS 34A and 34B in order for them to store enough samples to generate the output signals OS. These FIGS. 5B and 5C are described later.

In step S4, the control circuit 40 reads one sample from either the DRAM 34A or the DRAM 34B, and sends that sample to the output register 36. To select the proper DRAM, the control circuit 40 includes a flip-flop that generates a P1 (PLAY1) signal. This P1 signal is a “1” whenever the sample should be read from the DRAM 34A, and otherwise is a “0”.

In step S5, the control circuit 40 refreshes certain portions of the DRAMS 34A and 34B. A calculation, regarding the number of refresh commands to issue in each cycle of FIG. 4, is described later herein in conjunction with FIG. 5D.

In step S6, the control circuit 40 updates four addresses WA1, RA1, WA2, and RA2. Those addresses are held by respective registers within the control circuit 40. Address WA1 is used in step S3 to write one sample into the DRAM 34A, and address RA1 is used in step S4 to read one sample from the DRAM 34A. Similarly, address WA2 is used in step S3 to write one sample into the DRAM 34B, and the address RA2 is used in step S4 to read one sample from the DRAM 34B.

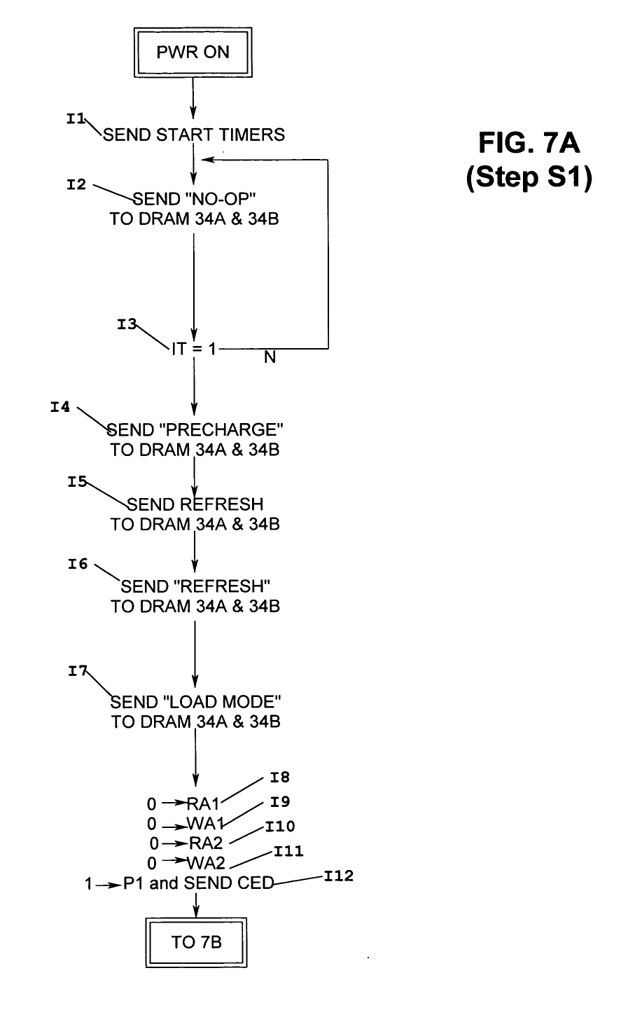

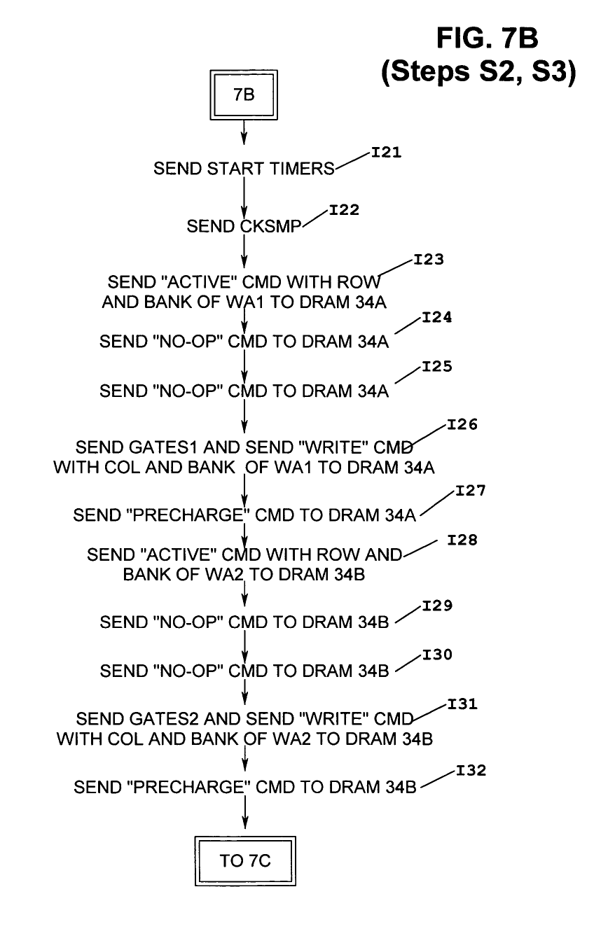

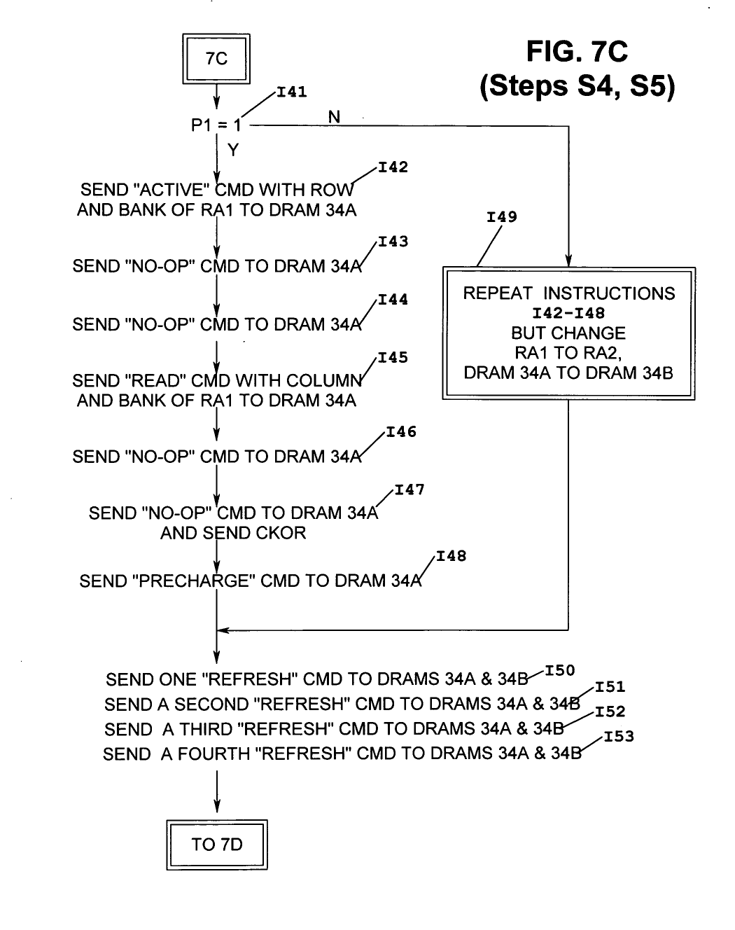

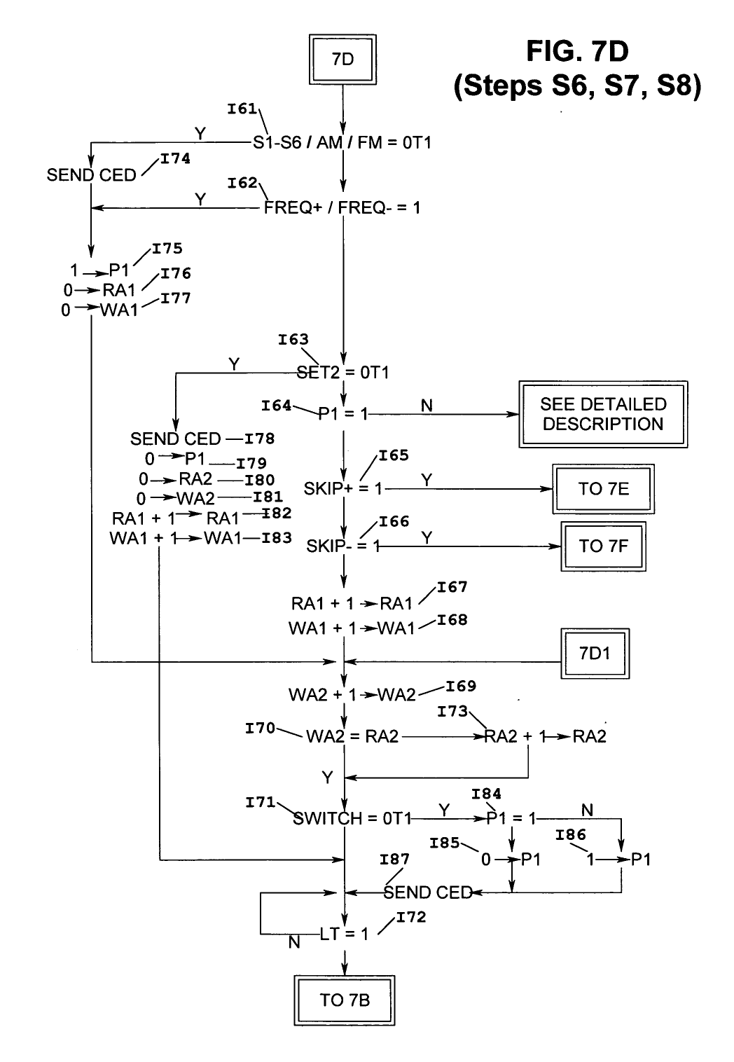

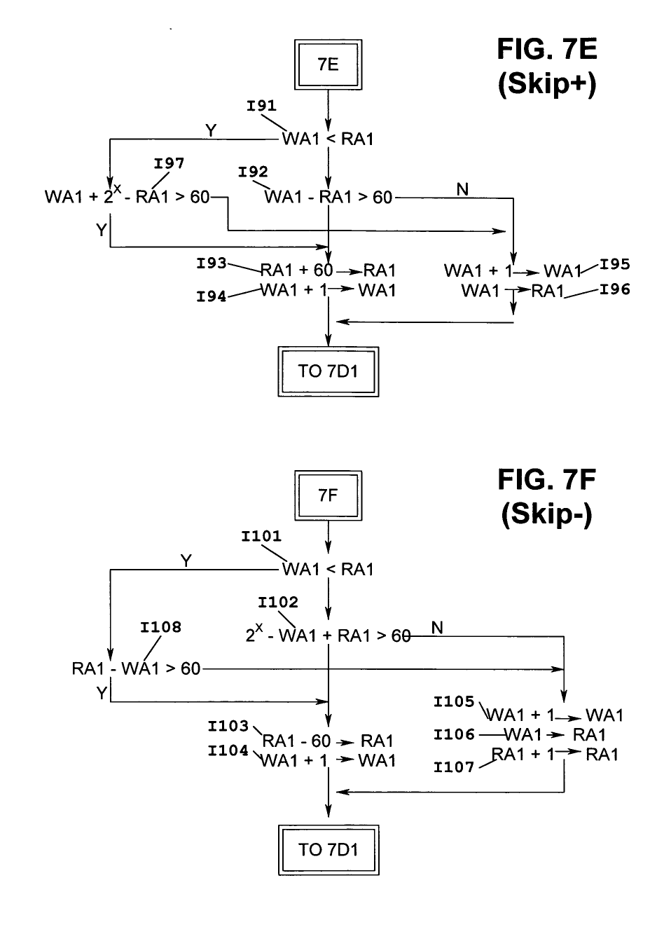

To update the addresses WA1, RA1, WA2 and RA2, the control circuit 40 first senses the state of the pushbuttons 12B-12K. This is done by sensing the signals that are sent on the connectors 41 in FIG. 2. Additional details regarding the actual updating of the addresses WA1, RA1, WA2 and RA2 are described later herein in conjunction with FIGS. 7D, 7E, and 7F.

In step S7, the control circuit 40 updates the P1 signal which it uses in step S4. This update is made in response to any one of the pushbuttons 12B-12L. For example, each time the SWITCH pushbutton 12L is pushed, the state of the P1 signal is changed from “1” to “0”, or from “0” to “1”.

Lastly, in step S8, the control circuit 40 waits for the loop timer to time-out. This loop timer was started back in step S2. When the time-out occurs, the control circuit 40 jumps back to step S2 and again performs the steps S2-S8.

By performing steps S2-S8 in a timed loop as described above, the RS1 samples which are taken by step S3 will be equally spaced in time. Likewise, the RS2 samples which are taken by step S3 will be equally spaced in time, and the samples which are sent to the output register 36 in step S4 will be equally spaced in time. This equal time spacing of the samples is needed to generate high quality sound with the output signals OS. In FIG. 4, the equal time spacing of the samples will occur even though steps S5-S7 last for a variable time duration which depends on the state of the pushbuttons 12B-12M.

Next, with reference to FIG. 5A, a suitable time period for the loop timer of steps S2-S8 in FIG. 4 will be calculated. To begin, equation E1 in FIG. 5A says that in each execution of steps S2-S8, the signals RS1 and RS2 are sampled only one time. This sampling is included in the write operation in step S2.

The RS1 and RS2 signals vary in frequency just like sound varies in frequency in the two received broadcasts. Also, the highest frequency which an average person can hear is about 20 KHz. Thus the highest frequency in the RS1 and RS2 signals is about 20 KHz, and this is stated by equation E2.

In order to accurately reproduce the RS1 and RS2 signals from their samples, the rate at which the samples are taken must be at least twice the highest frequency which the RS1 and RS2 signals contain. Thus the sampling rate by repeating steps S2-S8 must be at least 40,000 samples per second. For example, one suitable sampling rate is stated by equation 3 as 44,100 samples per second.

By taking the inverse of sampling rate in equation E3, a time period of 22.675 microseconds is obtained. That is the time which passes between two successive samples if the sampling rate is set at 44.1 KHz. Thus, the time period of the loop timer for steps S2-S8 in FIG. 4 must be set to 22.675 microseconds in order to achieve the 44.1 KHz sampling rate. This time period is stated by equation E4.

Next, reference should be made to FIG. 5B where a calculation is made to determine how much time it takes to completely fill a single DRAM chip with samples of the RS1 (or RS2) signals when 44,100 samples are being taken every second. This calculation begins with equation E10 which says that by sampling the RS1 signal for just ten minutes at a rate of 44,100 samples per second, the total number of samples taken is 26,460,000.

Also, the magnitude of each RS1 sample must be converted to a multi-bit binary number which is represented by digital voltages that are stored in the DRAM 34A. Equation E11 sets the number of bits per binary number equal to sixteen, as one suitable example. Multiplying sixteen bits per sample by 26,460,000 samples equals a total of 423,360,000 bits.

However, a single standard DRAM chip has a storage capacity of 512,000,000 bits. One specific example of such a chip is the 512 MbX16 synchronous DRAM which is sold by MICRON corporation. This particular chip stores 32,000,000 words of sixteen bits per word. Thus, a single 512 MbX16 chip will store 12.09 minutes of samples from the RS1 signals when the sampling rate is 44,100 samples per second and each sample is stored as a sixteen bit binary number. This is indicated by equation E12.

Another example of a specific DRAM chip is the 512 MbX8 synchronous DRAM which also is sold by MICRON corporation. This particular chip stores 64,000,000 words of 8 bits per word. Thus, two 512 MbX8 chips in parallel will store 24.18 minutes of samples from the RS1 signals when the sampling rate is 44,100 samples per second and each sample is stored as a sixteen bit binary number. This is indicated by equation E13.

Next, with reference to FIG. 5C, several calculations will be made to determine how long the samples of the program segments in FIG. 3 are temporarily stored in the DRAMS 21A and 32B. To begin, equation E20 in FIG. 5C says that time instant T4 in FIG. 3 occurs sixteen and one-half minutes after the starting time T1. This time T4 equals six minutes for program break PB2a plus ten minutes for program segment PS2a plus one-half minute to skip over program break PB1a.

Equation E21 in FIG. 5C says that the program segment PS1a starts to be received in the RS1 signals nine minutes after time T1. Thus it follows that the program segment PS1a is stored in the DRAM 34A a total of seven and one-half minutes before it is played in the output signals OS. This calculation is made by equation E22.

Similarly, equation 23 in FIG. 5C says that time instant T10 in FIG. 3 occurs forty-one minutes after the starting time T1. This time T10 equals six minutes for T1 to T2 plus the time duration of all of the program segments PS2a through PS1b in the output signals OS plus one-half minute for each program break that is skipped in the output signal.

Equation E24 in FIG. 5C says that the program segment PS2c starts to be received in the RS2 signals a total of thirty-three minutes after time T1. Thus it follows that the program segment PS2c is stored in the DRAM 34B a total of eight minutes before it is played in the output signals OS. This calculation is made by equation 25.

Likewise, equation E26 in FIG. 5C says that the time instant T16 in FIG. 3 occurs sixty-five and one-half minutes after the starting time T1. This time T16 equals six minutes for T1 to T2 plus the time duration of all of the program segments PS2a through PS2d in the output signals OS plus one-half minute for each program break that is skipped in the output signal.

Equation E27 in FIG. 5C says that the program segment PS1d starts to be received in the RS1 signals a total of fifty-five minutes after time T1. Thus it follows that the program segment PS1d is stored in the DRAM 34A a total of ten and one-half minutes before it is played in the output signals OS. This calculation is made by equation E28.

The above calculations which are made by equations E20-E22 for program segment PS1a, by equations E23-E25 for program segment PS2c, and by equations E26-E28 for program segment PS1d can also be made in a similar fashion for each program segment that occurs in the output signal OS of FIG. 3. Making these calculations shows that if each DRAM 34A and 34B consists of just a single 512 MbX16 chip, then all of the program segments PS2a-PS1d can be regenerated in the output signal OS.

Recall that slightly more than twelve minutes of samples of the RS1 and RS2 signals can be stored in a single 512 MbX6 DRAM chip. This was calculated by equations 10-12 of FIG. 5B.

Preferably, the control circuit 40 writes the samples of the RS1 and RS2 signals into the DRAMS 34A and 34B such that each new sample replaces the sample that was least recently stored. Thus, when DRAM 34A is a single 512 MbX16 chip, each new sample which is written into that DRAM 34A replaces a sample which was written about twelve minutes earlier. In other words, each sample is only stored temporarily in the DRAMS 34A and 34B for about twelve minutes, when those DRAMS each consist of a single 512 MbX16 chip.

Twelve minutes of temporary storage in DRAM 34A is longer than the seven and one-half minutes of storage for program segment PS1a that was calculated by equation 22. Similarly, twelve minutes of temporary storage in DRAM 34B is longer than the eight minutes of storage for program segment PS2c that was calculated by equation 25. Likewise, twelve minutes of temporary storage in DRAM 34A is longer than the ten and one-half minutes of storage for program segment PS1d that was calculated by equation 28.

By providing only twelve minutes of temporary storage in each DRAM 34A and 34B, and writing each new sample over the sample that was least recently written, portions of the program segments are skipped automatically without even using the SKIP pushbutton 12M. This is evident by determining what is stored in the DRAM 34A or 34B at a time instant when the DRAM is selected by the SWITCH pushbutton 12L to send samples to the output register 36.

For example, at time T15 in FIG. 3, the SWITCH pushbutton 12L is pushed to send samples of the RS1 signals from DRAM 34A to the output register 36. Time T15 in FIG. 3 occurs sixty-five minutes after time T1, and only twelve minutes of samples are stored in the DRAM 34A.

Thus it follows that at time T15, the least recent sample in DRAM 34A was written there fifty-three minutes after time T1. But, inspection of the RS1 signals in FIG. 3 shows that the program break PB1d starts forty-seven minutes after time T1 and ends fifty-five minutes after time T1. Consequently, the initial six minutes of the program break PB1d are skipped automatically.

As the amount of temporary storage which is provided by each DRAM 34A and 34B is increased, the cost of each DRAM increases. Conversely, as the amount of temporary storage which is provided by each DRAM 34A or 34B is decreased, the risk increases of automatically skipping one complete program break and the starting portion of the next program segment in the output signal OS. Preferably, each DRAM 34A and 34B temporarily stores between ten minutes of samples and thirty minutes of samples. This is achieved by constructing each DRAM 34A and 34B out of a single 512 MbX16 chip as previously indicated by equation 12 in FIG. 5B, or alternatively by constructing each DRAM 34A and 34B out of two 512 MbX8 chips as previously indicated in equation 13 in FIG. 5B.

Next, with reference to FIG. 5D, additional details will be described regarding the “refreshing” of the DRAMS 34A and 34B. All dynamic memory chips need to be periodically sent a certain number of “refresh commands” in order for those chips to work properly.

For example, the 512 MbX16 DRAM chip and the 512 MbX8 DRAM chip from MICRON corporation each need to be sent a total of at least 8,192 refresh commands every sixty-four milliseconds. This is stated by equation E30 in FIG. 5D. Dividing sixty-four milliseconds by 8,192 yields a rate of 7.81 microseconds per refresh command, and this is stated by equation E31 in FIG. 5.

Refresh commands are sent to the DRAMS 34A and 34B by step S5 in FIG. 4. That step S5 is performed once each time the loop S2-S8 is performed, and the loop S2-S8 is performed every 22.675 microseconds. Consequently, the number of refresh command which must be sent by each execution of step S2 is an integer which is equal to or larger than 22.675 microseconds divided by 7.81 microseconds. This is stated by equation E32. Thus, step S5 in FIG. 5 issues four refresh commands, and this is stated by equation E33.

Next, with reference to FIG. 6, one preferred internal structure for the control circuit 40 will be described. This control circuit 40 was previously shown in FIG. 2 as a labeled box which has certain inputs and outputs. TABLE 2 below identifies all of the major components which are in the control circuit 40 of FIG. 6.

TABLE 2

| REF. NUMBER | COMPONENT |
|---|---|
| 42 | Component 42 is an edge detection circuit |
| 43 | Component 43 is a multiplexor circuit |
| 44 | Component 44 is a read-only-memory (ROM) |
| 45 | Component 45 is a register |
| 46 | Component 46 is a clock generator (CG) |
| 47 | Component 47 is a read-only-memory (ROM) |
| 48 | Component 48 is a memory address unit (MAU) |
| 49 | Component 49 is a timing circuit (TC) |

In FIG. 2, the control circuit 40 is shown as being connected to the operator control panel 11 by a set of conductors 41. All of the conductors in the set 41 are separately shown in FIG. 6 as conductors 41A-41I. These conductors 41A-41I constitute an interface for receiving commands from an operator that select the spaced-apart segments of the RS1 signals and the RS2 signals that are interleaved in the output signals OS.

Conductor 41A carries a signal SW which is a “1” as long as the SWITCH pushbutton 12L in the operator control panel 11 is being pushed. Similarly, conductors 41B through 41I carry respective signals which are a “1” as long as a corresponding pushbutton in the operator control panel 11 is being pushed. The correspondence between the signals and the pushbuttons is shown below in TABLE 3.

TABLE 3

| SIGNAL | CORRESPONDING PUSHBUTTON |
|---|---|
| SW | The Switch pushbutton 12L |
| SET2 | The SET2 pushbutton 12K |
| FM | The FM pushbutton 12C |
| AM | The AM pushbutton 12B |
| PS1PS6 | The logical “or” of pushbuttons 12E-12J |
| SK+ | The “+” side of SKIP pushbutton 12M |
| SK− | The “−” side of SKIP pushbutton 12M |
| FR+ | The “+” side of Frequency pushbutton 12D |
| FR− | The “−” side of Frequency pushbutton 12D |

In FIG. 6, the signals SW, SET2, FM, AM, and PS1PS6 are sent on the conductor 41A-41E to an edge detection circuit 42. This circuit 42 includes five flip-flops (not shown). The first flip-flop is set to a “1” when the SW signal makes a “0” to “1” transition; the second flip-flop is set to a “1” when the SET2 signal makes a “0” to “1” transition; etc. Output signals from those five flip-flops occur on conductors 42A-42F. These flip-flops are cleared to a “0” when circuit 42 is sent a CLEAR EDGE DETECTOR signal CED.

All of the signals on the conductors 42A-42E, and all of the signals on the conductors 41F-41I, are sent to a multiplexor circuit 43. Also, the multiplexor 43 is sent a “1” on conductor 43A and three additional signals on conductors 48G, 49C and 49D. These three additional signals are described later.

Multiplexor 43 operates to selectively pass one of the signals on the conductors 42A-42E, 41F-41I, 43A, 48G, 49C, and 49D to its output 43B. This occurs in response to four selection signals SEL(1)-SEL(4) which are sent to control inputs 43C on multiplexor 43.

Output 43B from multiplexor 43 is sent to one address terminal 44A on the ROM 44. Simultaneously, the output signals from register 45 are also sent on conductors 45A to other address terminals 44B on the ROM 44. The signals on the address terminals 44A and 44B constitute a single address. In response to the signals on the address terminals 44A-44B, the ROM 44 generates output signals on conductors 44C. These ROM output signals are stored in register 45 when a “0” to “1” transition occurs in the CLOCK signal which is sent by the clock generator 46 on conductor 46A.

Thus, components 42-46 are the heart of a sequential state machine. The current state of this state machine is held in register 45. The next state of this state machine is stored in ROM 44, and it is read from ROM 44 on conductors 44C in response to the signals on the conductors 43B and 45A. The state machine always starts in state zero due to the PWR signal on conductor 45B which clears register 45 when power is turned-on.

Each signal on the conductors 41A-41I constitutes a command from an operator which directs the operation of the state machine 42-46. In particular, these commands determine what the state machine does when it performs steps S6 and S7 in FIG. 4. This is described later in detail in conjunction with FIGS. 7D, 7E, and 7F.

All of the output signals from register 45 are also sent on the conductors 45A to address terminals 47F on the ROM 47. A control program 47A is stored within the ROM 47, and one instruction in that control program is read in response to the signals on the address terminals 47F.

Each instruction which is read from the ROM 47 generates four sets of control signals on respective sets of conductors 47B, 47C, 47D, and 47E. The control signals on the conductors 47B are SEL(1)-SEL(4) which direct the multiplexor 43 to select and pass one signal to its output 43B. By selecting the “1” on conductor 43A, the state machine 42-46 proceeds unconditionally from one state to another.

The control signals on the conductors 47C are CKSMP, GATES1, GATES2, SELR1, SELR2, CKOR, CED, and ST. The CKSMP signal directs the A/D converters 32A and 32B in FIG. 2 to take a sample of the RS1 and RS2 signals. The GATES1 and GATES2 signals direct the A/D converter 32A and 32B in FIG. 2 to gate their sample onto the SBUS 33. The SELR1 and SELR2 signals respectively select the DRAMS 34A and 34B in FIG. 2 to perform various operations, such as read and write. The CKOR signal directs the output register 36 in FIG. 2 to load a sample from the SBUS 36. The CED signal directs the edge detection circuit 42 in FIG. 6 to clear its internal flip-flops. The ST signal directs the timer circuit 49 to start two internal timers.

The control signals on the conductors 47D are RAS, CAS, WE, and DQM. Those conductors 47D constitute a portion of the CBUS in FIG. 2. The remaining portion of the CBUS is the conductors 48F from the memory address unit 48, and those conductors 48F carry address signals ADDR. All of the signals RAS, CAS, WE, DQM, and ADDR are shown below in TABLE 4.

The signals RAS, CAS, WE, and DQM together define commands which the DRAMS 34A and 34B execute. Each DRAM 34A or 34B will execute a command that it is sent only if it is concurrently selected by the SELR1 or SELR2 signals.

TABLE 4

| COMMAND | RAS | CAS | WE | DQM | ADDR |
|---|---|---|---|---|---|
| NO-OP | H | H | H | NA | NA |
| ACTIVE | L | H | H | NA | ROW, BANK |
| READ | H | L | H | L | COLUMN, BANK |
| WRITE | H | L | L | L | NA |
| PRECHARGE | L | H | L | NA | A10 = 1 |
| REFRESH | L | L | H | NA | NA |
| LOAD MODE | L | L | L | NA | OP CODE |

The control signals on the conductors 47E are sent to the memory address unit 48. Then in response to those control signals, one of the things which the memory address 48 unit does is internally generate four addresses RA1, RA2, WA1, and WA2. These four addresses are held by separate registers 48A, 48B, 48C, and 48D inside the memory address unit 48.

To read a sample from the DRAM 34A, the RA1 address is partitioned into the ROW address, COLUMN address, and BANK address that is shown in TABLE 4. Similarly, address WA1 is partitioned into ROW, COLUMN, and BANK addresses to write a sample into the DRAM 34A; address RA2 is partitioned into ROW, COLUMN, and BANK addresses to read a sample from the DRAM 34B; and, address WA2 is partitioned into ROW, COLUMN, and BANK addresses to write a sample into the DRAM 34B.

The number of address bits in each of the addresses RA1, WA1, RA2, and WA2 depends on the number of storage cells in the DRAMS 34A and 34B. In the case where each DRAM 34A and 34B is a single 512 MbX16 chip, each address RA1, WA1, RA2, and WA2 is twenty-five bits long. Thirteen of these bits address a row; ten of these bits address a column; and two of these bits address a bank.

By comparison, in the case where each DRAM 34A and 34B is a pair of 512 MbX8 chips in parallel, then each address RA1, WA1, RA2, and WA2 is twenty-six bits long. Thirteen of these bits address a row; eleven of these bits address a column; and two of these bits address a bank.

To generate the address RA1, WA1, RA2, and WA2, the memory address unit 48 performs all of the operations that are shown below in TABLE 5. The particular operation that is performed at any one time is selected by an encoded combination of the control signals on the conductors 47E.

TABLE 5
Address Generating Operations

| | |
|---|---|
| 0→RA1 | 0→RA2 |
| RA1 + 1→RA1 | RA2 + 1→RA2 |
| RA1 + 60→RA1 | RA2 + 60→RA2 |
| RA1 − 60→RA1 | RA2 − 60→RA2 |
| WA1→RA1 | WA2→RA2 |
| 0→WA1 | 0→WA2 |
| WA1 + 1→WA1 | WA2 + 1→WA2 |

Each time the memory address unit 48 performs any of the operations in TABLE 5, the result of that operation is loaded into the proper registers 48A-48C when the next “0” to “1” transition of the CLOCK signal occurs. For example, if the memory address unit performs the operation of RA1+1→RA1, the result of RA+1 is loaded into register 48A on the next “0” to “1” transition in the CLOCK signal.

TABLE 6 below shows all of the items which are gated from the memory address unit 48 onto the conductors 48F as the ADDR signals. These items include the ROW, COLUMN, and BANK portions of the addresses RA1, WA1, RA2, and WA2. These items also include the OP-CODE for the LOAD MODE command, and bit A10=1 for the PRECHARGE command, as previously shown in TABLE 4. The particular item which is gated as the ADDR signals is selected by the control signals on the conductors 47E.

TABLE 6
ADDR Signals

| | |
|---|---|
| ADDR = ROW, BANK of WA1 | ADDR = ROW, BANK of WA2 |
| ADDR = COLUMN, BANK of | ADDR = COLUMN, BANK of WA2 |
| WA1 | |
| ADDR = ROW, BANK of RA1 | ADDR = ROW, BANK of RA2 |
| ADDR = COLUMN, BANK of | ADDR = COLUMN, BANK of RA2 |
| RA1 | |

ADDR = OP-CODE
BIT A10 OF ADDR = 1

The memory address unit 48 also performs several tests on the addresses RA1, WA1, RA2, and WA2. These tests are shown in TABLE 7. The particular test which is performed at one time is selected by an encoded combination of the control signals in the conductors 47E. If the selected test is true, the memory address unit 48 generates the ATEST signal as a “1” on conductor 48G. Otherwise, the memory address unit 48 generates the ATEST signal as a “0”. The ATEST signal remains in the above state until the next “0” to “1” transition of the CLOCK signal.

TABLE 7
Address Tests

| | |
|---|---|
| WA1 = RA1 | WA2 = RA2 |
| WA1 < RA1 | WA2 < RA2 |
| WA1 − RA1 > 60 | WA2 − RA2 > 60 |
| RA1 − WA1 > 60 | RA2 − WA2 > 60 |
| 2^{X} + WA1 − RA1 > 60 | 2^{X} + WA2 − RA2 > 60 |
| 2^{X} − WA1 + RA1 > 60 | 2^{X} − WA2 + RA2 > 60 |

The exponent “X” is 25 if each DRAM is one 512 Mb × 16 chip.
The exponent “X” is 26 if each DRAM is two 512 Mb × 8 chips.

The memory address unit 48 also keeps track of which DRAM 34A or 34B is the current source of samples for the output register 36. To do that, the memory address unit 48 includes a flip-flop 48E which generates a P1 (PLAY1) signal. The signal P1 is a “1” when DRAM 34A is the current source of samples for the output register 36. Otherwise, the signal P1 is a “0”.

To set the P1 signal to a “1”, flip-flop 48 is set by one encoded combination of the control signals on the conductors 47E. Similarly, to reset the P1 signal to a “0”, flip-flop 48 is reset by a second encoded combination of the control signals on the conductors 47E. Also, to test the state of the P1 signal, that signal is sent on conductor 48G to the multiplexor 43. This occurs in response to a third combination of the control signals on the conductors 47E. All of this is shown by TABLE 8 below.

TABLE 8

| P1 Operation | P1 Tests |
|---|---|
| 1→P1 | P1 = 1 |
| 0→P1 | |

The only remaining component in the FIG. 6 control circuit is the timing circuit 49. It includes a loop timer 49A and an initialization timer 47B. Both of these timers 49A and 49B are started by the ST (Start Timer) signal which is sent on one of the conductors 47C.

The loop timer 49A generates an output signal LT on conductor 49C. The LT signal is generated as a “0” when the loop timer 49A is started by the ST signal. Then 22.675 microseconds later, the LT signal is generated as a “1”. This LT signal is sent on conductor 49C to the multiplexor 43 so it can be tested.

Similarly, the initialization timer 47B generates an output signal IT on conductor 49D. The IT signal is generated as a “0” when the initialization timer 49B is started by the ST signal. Then 100 microseconds later, the IT signal is generated as a “1”. This IT signal is sent on conductor 49D to the multiplexor 43 so it can be tested.

Next, with reference to FIGS. 7A-7F, the control program 47A which is stored in the ROM 47 will be described. Each instruction in this control program 47A generates the control signals on the conductors 47B, 47C, 47D and 47E from the ROM 47. In response to these control signals, all of the previously described steps S1-S8 of FIG. 4 are performed.

To begin, the instructions I1-I12 which are shown in FIG. 7A will be described. Those instructions perform the initialization step S1 of FIG. 4. These instructions are executed when the electronic device 10 of FIG. 1 is powered-on by pushbutton 12A.

The first instruction I1 sends the ST signal to start the initialization timer 49B in FIG. 6. Next, instruction I2 sends a NO-OP command to the DRAMS 34A and 34B. Then, instruction I3 tests the state of the IT signal. That IT signal will be generated as a “0” when instruction I1 is executed, and will be generated as a “1” one-hundred microseconds later. As long as the IT signal tests as a “0”, a branch is taken from instruction I3 back to instruction I2. Consequently, NO-OP commands are sent to the DRAMS 34A and 34B for one-hundred microseconds. This is one requirement for initializing the 512 MbX16 and 512 MbX8 DRAM chips from Micron corp.

When the IT signal tests as a “1”, then a branch is taken from instruction I3 to instruction I4. That instruction I4 sends a “PRE-CHARGE” command to the DRAMS 34A and 34B. Then, instruction I5 sends one “REFRESH” command to the DRAMS 34A and 34B, and instruction I6 sends another “REFRESH” command to the DRAMS 34A and 34B. This is a second requirement for initializing the above 512 MbX16 and 512 MbX8 chips.

Then, instruction I7 sends a “LOAD MODE” command to the DRAMS 34A and 34B. As part of this command, an “OP CODE” is sent by the MAU 48 as the ADDR signals on the conductors 48G. The first four bits of the ADDR signals are “0000”, and this tells the DRAMS 34A and 34B that all READ and WRITE commands are single location accesses (non-burst accesses). The next three bits of the ADDR signals are “010”, and this specifies a CAS latency of two. This means that when the DRAM 34A or 34B executes a READ command, the sample that is read will be sent to the SBUS two CLOCK cycles after the READ command is sent. The next two bits of the ADDR signals are “00”, and this selects a standard operating mode in the DRAMS 34A and 34B (as opposed to a test mode of operation). The remaining four bits are “0000”. All of this is the last requirement for initializing the above 512 MbX16 and 512 MbX8 chips.

Then, the initialization step S1 is completed by executing instructions I8-I12. The instructions I8-I11 set all of the addresses RA1, WA1, RA2, and WA2 to zero. The last instruction I12 sets the P1 flip-flop to a “1” and clears the edge detector 42.

Next, the instructions I21-I32 shown in FIG. 7B are executed. These instructions I21-I32 together perform steps S2 and S3 of FIG. 4.

The first instruction I21 sends the ST signal to start the loop timer 49A. Then, instruction I22 sends the CKSMP signal. This causes one analog sample of the RS1 signals to be taken by the A.D converter 32A and one analog sample of the RS2 signals to be taken by the A/D converter 32B.

Then, instructions I23-I27 together write one sample from the A/D converter 32A into the DRAM 34A. To do that, instruction I23 first sends an “ACTIVE” command to the DRAM 34A along with the ROW and BANK portion of WA1. Then instructions I24 and I25 send two “NO-OP” commands to the DRAM 34A. Then instruction I26 sends GATES1 and sends a “WRITE” command to the DRAM 34A along with the COLUMN and BANK portion of WA1. The GATES1 signal causes one digital sample to be sent from the A/D converter 32A to the DRAM 34A. Lastly, instruction I27 sends a “PRECHARGE” command to the DRAM 34A.

Then, instructions I28-I32 together write one sample from the A/D converter 32B into the DRAM 34B. To do that, instruction I28 first sends an “ACTIVE” command to the DRAM 34B along with the ROW and BANK portion of WA2. Then instructions I29 and I30 send two “NO-OP” commands to the DRAM 34B. Then instruction I31 sends GATES2 and sends a “WRITE” command to the DRAM 34B along with the COLUMN and BANK portion of WA2. The GATES2 signal causes one digital sample to be sent from the A/D converter 32B to the DRAM 34B. Lastly, instruction I32 sends a “PRECHARGE” command to the DRAM 34B.

Next, the instructions shown in FIG. 7C are executed. These instructions together perform steps S4 and S5 of FIG. 4.

Instruction I41 begins by testing the state of the P1 signal. If P1 is a “1”, then one sample of RS1 needs to be read from the DRAM 34A and sent to the output register 36. This is achieved by the instructions I42-I48.

Instruction I42 sends an “ACTIVE” command to the DRAM 34A along with the ROW and BANK portion of RA1. Then instructions I43 and I44 send two “NO-OP” commands to the DRAM 34A. Then instruction I45 sends a “READ” command to the DRAM 34A along with the COLUMN and BANK portions of RA1. Then instructions I46 and I47 send two “NO-OP” commands to the DRAM 34A. When the second “NO-OP” command is sent by instruction I47, the DRAM 34A sends one sample onto the SBUS 33. This sample is stored in the output register 36 by instruction I47 which sends CKOR. Lastly, instruction I48 sends a “PRECHARGE” command to the DRAM 34A.

Conversely, if instruction I41 determines that P1 is a “0”, then one sample of RS2 needs to be read from the DRAM 34B and sent to the output register 36. This is achieved by the group of instructions I49. These instructions I49 are the same as the above described instructions I42-I48 except that RA1 is changed to RA2, and DRAM 34A is changed to DRAM 34B.

Lastly, in FIG. 7C, instructions I50-I53 are executed. These instructions send four “REFRESH” commands to both of the DRAMS 34A and 34B. This is consistent with equations 30-33 of FIG. 5D which were previously described.

Next, the instructions shown in FIG. 7D are executed. These instructions together perform parts of steps S6, S7 and S8 in FIG. 4.

In FIG. 7D, the main path follows the instructions I61-I72. This path is taken when none of the pushbuttons 12B-12M have been pushed, and samples of the RS1 signals are being sent to the output register 36.

The above path begins with three instructions I61 which respectively test three different signals from the edge detector circuit 42. The first instruction tests the edge detector signal on conductor 42C; the second instruction tests the edge detector signal on conductor 42D; and the third instruction tests the edge detector signal on conductor 42E. These tests determine if a “0” to “1” transition occurred in any of the pushbutton signals AM or FM or PS1-PS6.

If none of the pushbutton signals AM or FM or PS1-PS6 made a “0” to “1” transition, then two more instructions I62 are executed which respectively test two additional pushbutton signals. The first instruction tests the FREQ+ signal, and the second instruction tests the FREQ− signal.

If the FREQ+signal and the FREQ− signal are both a “0”, then instruction I63 is executed. Instruction I63 tests the edge detector signal on conductor 42B to thereby determine if the signal from the SET2 pushbutton made a “0” to “1” transition.

If no “0” to “1” transition in the SET2 signal is detected, then instruction I64 is executed. Instruction I64 tests the state of the P1 signal. The “1” state of the P1 signal indicates that address RA1 is currently being used to read samples from the DRAM 34A for the output register 36.

If the P1 signal is a “1”, then instructions I65 and I66 respectively test the SKIP+ signal and the SKIP− signal. These tests determine if the SKIP pushbutton is currently being pushed on either the “+” side or the “−” side.

If the SKIP+ signal and the SKIP− signal are both “0”, then instructions I67-I69 are executed. Instruction I67 adds one to the read address RA1; instruction I68 adds one to the write address WA1; and instruction I69 adds one to the write address WA2.

Due to instruction I68, consecutive samples of the RS1 signals are written into the DRAM 34A at consecutive addresses. Also, due to instruction I67, the RS1 samples which are sent to the output register 36 come from the DRAM 34A at consecutive addresses. Further, due to instruction I69, consecutive samples of the RS2 signals are written into the DRAM 34B at consecutive addresses. When any one of the addresses RA1, WA1, RA2, or WA2 reaches the largest address for the DRAMS 34A or 34B, then that address wraps back to zero if it is incremented by one.

After instruction I69 is executed, then instruction I70 determines if address WA2 equals address RA2. If those addresses are not equal, then instruction I71 tests the edge detector signal on conductor 42A to determine if the signal from the SWITHCH pushbutton made a “0” to “1” transition.

If no “0” to “1” transition in the signal from the SWITCH pushbutton is detected, then instruction I72 is executed. This instruction tests the LT signal from the loop timer 49A. As long as the LT signal is a “0”, the instruction I72 is re-executed. Thereafter, when the LT signal becomes a “1”, a branch is taken back to instruction I21 in FIG. 7B.

Next, suppose that in the execution of instruction I70, the addresses WA2 and RA2 were found to be equal. This means that the DRAM 34B is completely full of RS2 samples which have not been sent to the output register 36. When this occurs, a branch is taken to instruction I73 which increments the read address RA2 by one. As a result, the least recent sample in the DRAM 34B is automatically skipped; and, that least recent sample will be replaced with the most recent sample when the next WRITE command is sent to the DRAM 34B. From instruction I73, a branch is taken back to instruction I71.

Next, suppose that in the execution of instruction I61, one of the signals PS1-PS6 or AM or FM was found to have made a “0” to “1” transition. This means that the first radio receiver 21 stopped receiving one broadcast from one station and started receiving a new broadcast from a different station. When this occurs, a branch is taken to instructions I74-I77.

Instruction I74 sends CED to clear the edge detector 42. Instruction I75 sets P1 to a “1”, and this causes samples of the new broadcast to be sent from the DRAM 34A to the output register 36. Instructions I76 and I77 clear the addresses RA1 and WA1 to zero. As a result, samples of the new broadcast are written into and read from the DRAM 34A beginning at address zero. From instruction I77, a branch is taken back to instruction I69.

Next, suppose that in the execution of instruction I62, the signals FREQ+ or FREQ− are found to be a “1”. This means that FREQ pushbutton is being pushed. The first radio receiver 21 continuously receives a new broadcast in a different frequency band as long as the FREQ pushbutton stays pushed. To accommodate this event, a branch is simply taken from instruction I62 to the above described instructions I75-I77.

Next, suppose that in the execution of instruction I63, the SET2 signal is found to have made a “0” to “1” transition. This means the second radio receiver 22 is now starting to receive the same broadcast as the first radio receiver 21. When this occurs, a branch is taken from instruction I63 to instructions I78-I83.

Instruction I78 sends CED to clear the edge detector 42. Instruction I79 resets P1 to a “0”, and this causes samples of the RS2 signals to be sent from the DRAM 32B to the output register 36. Instructions I80 and I81 clear the address RA2 and WA2 to zero. As a result, samples of the RS2 signals are written into and read from the DRAM 32A beginning at address zero. Instructions I82 and I83 add one to the address RA1 and WA1. Then a branch is taken from instruction I83 back to instruction I72.

Next, suppose that in the execution of instruction I71, the SWITCH signal is found to have made a “0” to “1” transition. This means that the source of the samples which are being sent to the output register 36 should change. To achieve this, a branch is taken from instruction I71 to instructions I84-I87.

Instruction I84 tests the state of the P1 signal. If P1 is a “1”, then instruction I85 is executed which resets P1 to a “0”. Conversely, if P1 is a “0”, then instruction I86 is executed which sets P1 to a “1”. Then instruction I87 sends CED to clear the edge detector 42, and takes a branch back to instruction I72.

Next, suppose that in the execution of instruction I65, the SKIP+ signal is found to be a “1”. When that occurs, the instructions of FIG. 7E are executed.

In FIG. 7E, the main path follows the instructions I91-I94. The first instruction I91 tests to see if WA1 is less than RA1. If WA1 is less than RA1, then WA1 has wrapped past the largest address for the DRAM 34A but RA1 has not yet wrapped. Conversely, if WA1 is not less than RA1, then neither WA1 or RA1 have wrapped past the largest address for the DRAM 34A, or both WA1 and RA1 have wrapped.

If instruction I91 finds that WA1 is not less than RA1, then instruction I92 is executed. Instruction I92 tests to see if WA1 is larger than RA1 by more then sixty. If instruction I92 finds that WA1 is larger than RA1 by more then sixty, this means that the read address RA1 is far enough away from the write address WA1 to skip forward by sixty. Thus, instructions I93 and I94 are executed.

Instruction I93 adds sixty to the read address RA1, and instruction I94 adds one to the write address WA1. Then, a branch is taken back to instruction I69 in FIG. 7D.

Due to instruction I94, the samples of the RS1 signals continue to be stored at consecutive locations in the DRAM 34A. Due to instruction I93, only every sixtieth sample in the DRAM 34A is sent to the output register 36. Consequently, to skip forward past all of the RS1 samples which get stored in the DRAM 34A during a minute time period, the SKIP+ pushbutton needs to be pushed for only one second.

Next, suppose that instruction I92 finds that WA1-RA1 is not larger than sixty. This means that the read address RA1 is too close to the write address WA1 to continue skipping forward sixty samples at a time. In that case, a branch is taken to instructions I95 and I96.

Instruction I95 adds one to WA1, and instruction I96 makes RA1 equal to WA1. Due to instruction I95, the samples of the RS1 signals continue to be stored at consecutive locations in the DRAM 34A. Due to instruction I96, the sample that was most recently stored in the DRAM 34A will be the next sample that is sent to the output register 36. From instruction I96, a branch is taken back to instruction I69 in FIG. 7D.

Next, suppose that instruction I91 finds that WA1 is less than RA1. In that case, a branch is taken to instruction I97 which tests to see if WA1+2^{x}-RA1 is more than sixty. Here, 2^{x} is the total number of storage locations in the DRAM 34A.

If WA1+2^{x}-RA1 is found to be more than sixty, this means that the read address RA1 is far enough away from the write address WA1 to continue skipping forward sixty samples at a time. In that case, the instructions I93 and I94 are executed as described above. Otherwise, instructions I95 and I96 are executed as described above.

Next, suppose that in the execution of instruction I66, the SKIP− signal is found to be a “1”. When that occurs, the instructions of FIG. 7F are executed.

In FIG. 7F, the main path follows the instructions I101-I104. The first instruction I101 tests to see if WA1 is less than RA1. Here again, if WA1 is less than RA1, then WA1 has wrapped past the largest address for the DRAM 34A but RA1 has not yet wrapped.

If instruction I101 finds that WA1 is not less than RA1, then instruction I102 is executed. Instruction I102 tests to see if 2^{x}-WA1+RA1 is more than sixty (where 2^{x} is the total number of storage locations in the DRAM 34A). If instruction I102 finds that 2^{x}-WA1+RA1 is more than sixty, this means that the read address RA1 is far enough away from the write address WA1 to skip backward by sixty. Thus, instructions I103 and I104 are executed.

Instruction I103 subtracts sixty from the read address RA1, and instruction I104 adds one to the write address WA1. Then, a branch is taken back to instruction 169 in FIG. 7D.

Due to instruction I104, the samples of the RS1 signals continue to be stored at consecutive locations in the DRAM 34A. Due to instruction I103, only every sixtieth sample in the DRAM 34A is sent to the output register 36. Consequently, to skip backward past all of the RS1 samples which get stored in the DRAM 34A during a minute time period, the SKIP− pushbutton needs to be pushed for only one second.

Next, suppose that instruction I102 finds that 2^{x}-WA1+RA1 is not larger than sixty. This means that the read address RA1 is too close to the write address WA1 to continue skipping backward sixty samples at a time. In that case, a branch is taken to instructions I105-I107.

Instruction I105 adds one to WA1, and instructions I106-I107 make RA1 equal to WA1+1. Due to instruction I105, the samples of the RS1 signals continue to be stored at consecutive locations in the DRAM 34A. Due to instructions I106-I107, the sample that was least recently stored in the DRAM 34A will be the sample that is sent to the output register 36. From instruction I107, a branch is taken back to instruction I69 in FIG. 7D.

Next, suppose that instruction I101 finds that WA1 is less than RA1. In that case, a branch is taken to instruction I108 which tests to see if RA1-WA1 is more than sixty.

If RA1-WA1 is found to be more than sixty, this means that the read address RA1 is far enough away from the write address WA1 to continue skipping backward sixty samples at a time. In that case, the instructions I103 and I104 are executed as described above. Otherwise, instructions I105-I107 are executed as described above.

Lastly, suppose that in the execution of instruction I64 of FIG. 7D, the P1 signal is found to be a “0”. To handle that case, the above described instructions I65-I73, I84-I87, I91-I97, and I101-I108 are duplicated with the addresses RA1 and RA2 being swapped and with the addresses WA1 and WA2 being swapped. For example, instruction I67 is duplicated as RA2+1→RA2; instruction I70 is duplicated as WA1=RA1; instruction I91 is duplicated as WA2<RA2; etc. These duplicated instructions are stored in ROM 47 just like all of the instructions of FIGS. 7A-7F.

Now, the speed at which each instruction in FIGS. 7A-7F needs to be executed will be determined. To begin, recall that steps S2-S8 in FIG. 4 must be performed in 22.675 microseconds. Steps S2-S8 are performed by the instructions in FIGS. 7B-7F, and so the longest path through those instructions must not exceed 22.635 microseconds.

In FIG. 7B, a total of twelve instructions are always executed. In FIG. 7C, a total of thirteen instructions are always executed. In FIGS. 7D and 7E, a total of nineteen instructions are executed in the longest path. Thus, in each performance of steps S2-S8, a maximum of forty-four instructions are executed.

Dividing 22.675 microseconds by forty-four instructions yields 0.51 microseconds per instruction. The actual execution time per instruction needs to be shorter then 0.51 microseconds to have a margin of safety. For example, one suitable execution time per instruction would be 400 nanoseconds.

Each instruction in FIGS. 7A-7F is read from the ROM 47 and executed in a single cycle of the CLOCK signal. Thus, an instruction execution time of 400 nanoseconds is achieved by setting the frequency of the CLOCK signal to the inverse of 400 nanoseconds, which equals 2.5 MHz.

Consider now the storage capacity that is needed for each of the ROMS 44 and 47. ROM 47 stores all of the instructions that are shown in FIGS. 7A-7F plus the duplicated instructions that handle the case where P1 tests as a “0” in instruction I64. The total number of all those instructions is one-hundred-ten. To address that many instructions, the ROM 47 needs a nine bit address.

Each instruction is read from the ROM 47 on conductors 47B, 47C, 47D, and 47E. The SEL(1)-SEL(4) signals on the conductors 47B are four bits in each instruction. The CKSMP, GATES1, GATES2, SELR1, SELR2, CKOR, CED, and ST signals on the conductors 47C are eight more bits in each instruction. The RAS, CAS, WE, and DQM signals on the conductors 47D are four more bits in each instruction. The signals on the conductors 47E, which select entries from TABLE 5-TABLE 8, are eight more bits in each instruction.

Thus, each instruction in ROM 47 is twenty-four bits long. Further, since the ROM 47 has a nine bit address, the total number of bits in the ROM 47 is 512×24, or 12,288 bits.

The nine address bits for ROM 47 are read from the ROM 44 as the current state. Thus, each state in ROM 44 is nine bits long. Further, the ROM 44 is addressed by the nine bits that come from register 45 and one additional bit on conductor 43B. Thus, the total number of bits in the ROM 44 is 1024×9, or 9,216 bits.

The 12,288 bits in ROM 47 and the 9,216 bits in ROM 44 are very much smaller than the 512 million bits that are stored in a single 512MbX16 DRAM integrated circuit chip. Thus, if both ROM 47 and ROM 44 are fabricated in one custom chip, then a large amount of space will be left over in the chip to hold other components. This means that everything that is shown in FIG. 2, except the operator control panel 11 and the radio receivers 21-22, can be built with just one custom chip and two standard DRAM chips!

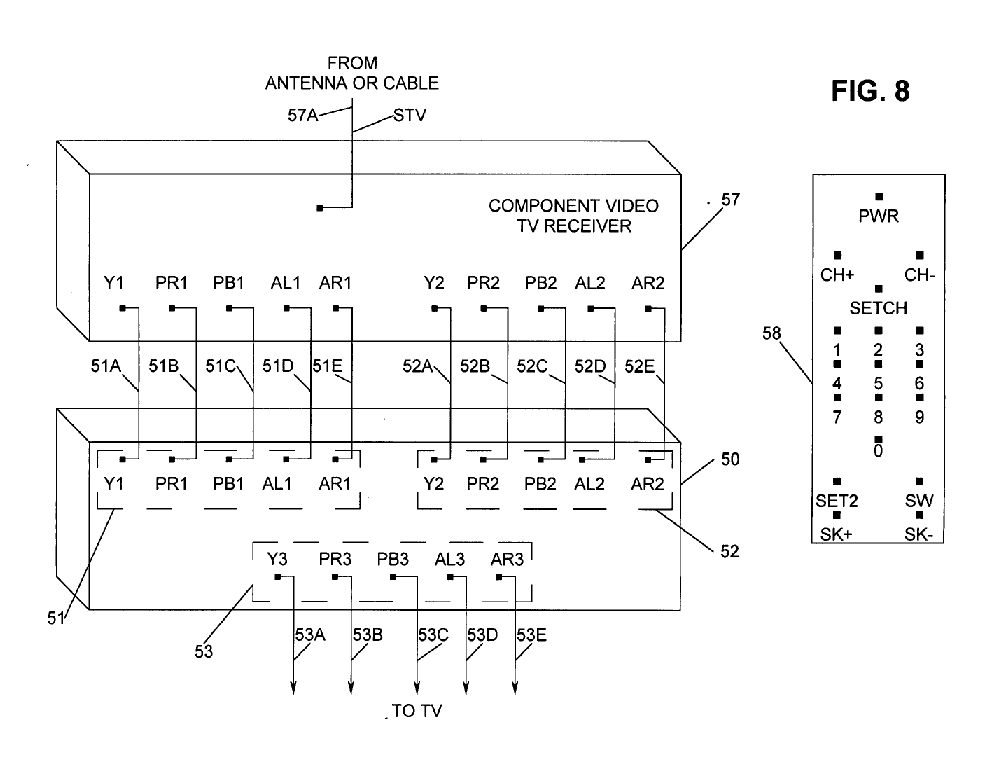

One preferred embodiment of the present invention has now been described in detail. Next, with reference to FIGS. 8-15, a second preferred embodiment will be described.

An overview of this second preferred embodiment is shown in FIG. 8 as an electronic device 50. This electronic device 50 receives first and second TV broadcasts simultaneously in separate frequency bands called channels. Also, while the two TV broadcasts are being received, the electronic device 50 temporarily stores both of those received broadcasts. Further, concurrently with the above operations, the electronic device 50 sends spaced-apart program segments from both of the temporarily stored TV broadcasts to a TV in an interleaved output sequence. All program breaks in the temporarily stored TV broadcast can be skipped in the interleaved output sequence by commands from an operator.

The electronic device 50 has two input ports 51 and 52, and one output port 53. The input port 51 receives five analog signals Y1, PR1, PB1, AL1, and AR1 on conductors 51A-51E; the input port 52 receives five analog signals Y2, PR2, PB2, AL2, and AR2 on conductors 52A-52E; and the output port 53 sends five analog signals Y3, PR3, PB3, AL3, and AR3 on conductors 53A-53E.

The five analog signals Y1, PR1, PB1, AL1, and AR1 represent a first received TV broadcast. Y1 is a luminance signal which indicates brightness in the TV picture. PR1 is a color difference signal which indicates how much red is in the TV picture relative to the luminance. PB1 is a color difference signal which indicates how much blue is in the TV picture relative to the luminance. AR1 is one stereo audio signal, and AL1 is another stereo audio signal. Similarly, the five analog signals Y2, PR2, PB2, AL2, and AR2 represent a second received TV broadcast.

Within the electronic device 50, the five signals Y1-AR1 are temporarily stored, and the five signals Y2-AR2 are temporarily stored. Also, while the storage of the above signals is occurring, the electronic device 50 generates the five output signals Y3-AR3 on the output port 53. These output signals include selectable spaced-apart segments of the stored Y1-AR1 signals which are interleaved with selectable spaced-apart segments of the stored Y2-AR2 signals.

The signals Y1-AR1 and Y2-AR2 are generated by a component video TV receiver 57. This component video TV receiver has an input 57A that is coupled to either a TV dish antenna or a TV cable. A signal STV on the input 57A concurrently carries multiple TV broadcasts in separate channels. From that signal STV, the signals Y1-AR1 and Y2-AR2 are generated in the component video receiver 57 by conventional circuitry.

Using a remote control handset 58, an operator sends various commands to the electronic device 50 and the component video TV receiver 57. This remote control handset 58 includes all of the pushbuttons which are shown in FIG. 8. Each pushbutton is described below in TABLE 9.

TABLE 9

| PUSHBUTTON | FUNCTION |
|---|---|
| PWR | The PWR pushbutton is |
| | pushed once to turn power |
| | on in the electronic device |
| | 50 and the component video |
| | TV receiver 57, and pushed |
| | again to turn power off. |
| 0-9 & SETCH | When the pushbuttons 0-9 |
| | are pushed followed by the |
| | SETCH pushbutton, the |
| | component video TV receiver |
| | 57 receives the first TV |
| | broadcast from the channel |
| | selected by the pushbuttons |
| | 0-9. The signals Y1-AR1 |
| | represent this first |
| | received TV broadcast. |
| CH+ | Each time the CH+ |
| | pushbutton is pushed, the |
| | component video TV receiver |
| | 57 increases the channel of |
| | the first received TV |
| | broadcast. |
| CH− | Each time the CH− |
| | pushbutton is pushed, the |
| | component video TV receiver |
| | 57 decreases the channel of |
| | the first received TV |
| | broadcast. |
| SET2 | When SET2 pushbutton is |
| | pushed, the component video |
| | TV receiver 57 receives the |
| | second TV broadcast from |
| | the same channel that is |
| | currently being received as |
| | the first TV broadcast. |
| | The signals Y2-AR2 |
| | represent this second |
| | received TV broadcast. |
| SW | When the SW pushbutton is |
| | pushed, the electronic |
| | device 50 sends the |
| | temporarily stored second |
| | received TV broadcast to |
| | the output port 53 if the |
| | temporarily stored first |
| | received TV broadcast is |
| | currently being sent to the |
| | output port, and visa- |
| | versa. |
| SK+ & SK− | These pushbuttons are |
| | pushed to skip over program |
| | breaks in the temporarily |
| | stored broadcast that is |
| | currently being sent to the |
| | output port 53. To skip |
| | forward, the SK+ pushbutton |
| | is pushed. To skip |
| | backward, the SK− |
| | pushbutton is pushed. The |
| | skipping occurs as long as |
| | the pushbutton is pushed. |

In operation, the PWR pushbutton in the handset 58 is initially used to power-on the electronic device 50 and the component video TV receiver 57. Also, another remote control handset (not shown) is used to power-on a TV (not shown) that receives the signals Y3-AR3 from the output port 53. Then, the pushbuttons 0-9, SETCH, CH+, CH− and SET2 are used to select the two TV broadcasts which are received simultaneously by the component video TV receiver 57. Thereafter, the pushbuttons SW, SK+, and SK− are used to select and interleave spaced-apart segments of the temporarily stored signals Y1-AR1 and Y2-AR2 in the output signals on port 53.

The pushbuttons SW, SK+, and SK− in the remote control handset 58 are used by an operator just like the pushbuttons +SKIP− and SWITCH are used in the previously described operator control panel 11 of FIG. 1. Thus, the previously described timing diagram of FIG. 3 directly illustrates the operation of the electronic device 50. For the electronic device 50, the signals RS1 and RS2 and OS in FIG. 3 are respectively replaced with the signals Y1-AR1 and Y2-AR2 and Y3-AR3. Also for the electronic device 50, the items PS1a-PS1d in FIG. 3 are program segments in the first received TV broadcast Y1-AR1, and the items PB1a-PB1e in FIG. 3 are program breaks in that first received TV broadcast. Similarly for the electronic device 50, the items PS2a-PS2d in FIG. 3 are program segments in the second received TV broadcast Y2-AR2, and the items PB2a-PB1e are program breaks in that second received TV broadcast.

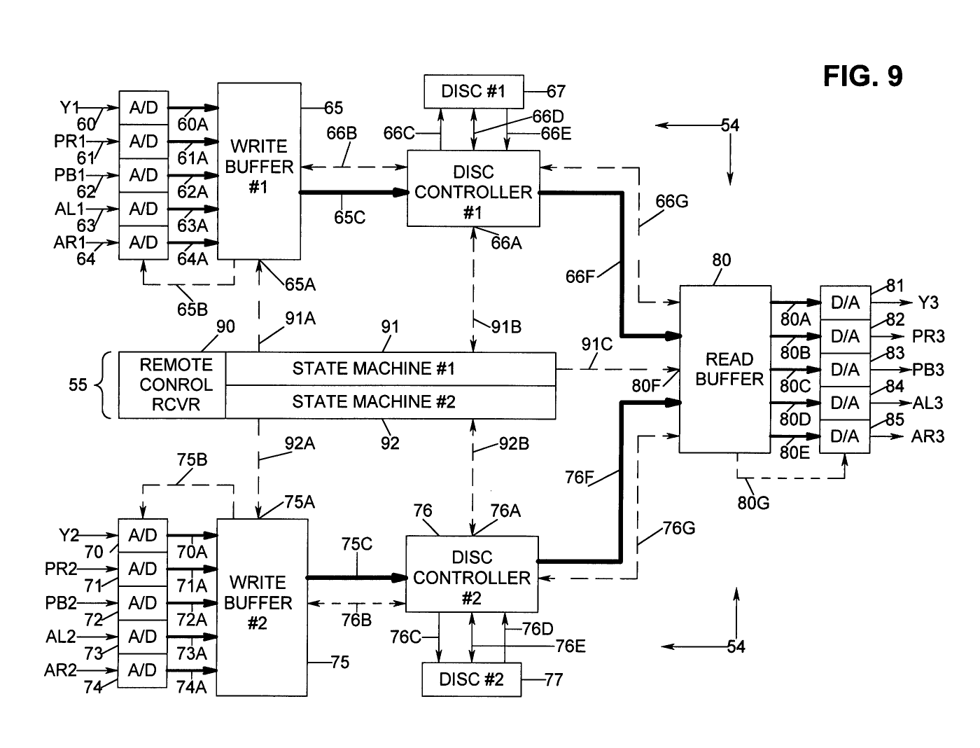

Next, with reference to FIG. 9, one preferred embodiment of the circuitry which is in the electronic device 50 of FIG. 8 will be described. This FIG. 9 circuitry is comprised of −1) a memory module 54 which includes components 60-67, 70-77, and 80-81, and 2) a control module 55 for the memory module 54 which includes components 90-92. All of these components are interconnected as shown in FIG. 9 by solid lines which represent conductors that carry data signals, and by dashed lines which represent conductors that carry control signals.

Components 60-64 are A/D converters. The A/D converter 60 samples the analog signal Y1 on the input port 51 at a rate of 13.5(10⁶) samples per second, and converts each analog sample to an eight bit digital sample. These digital samples occur on conductors 60A.

The A/D converter 61 samples the analog signal PR1 on the input port 51 at a rate of 6.75(10⁶) samples per second, and converts each analog signal to an eight bit digital sample. These digital signals occur on conductors 61A. Similarly, the A/D converter 62 samples the analog signal PB1 on the input port 51 at a rate of 6.75(10⁶) sample per second, and converts each analog sample to an eight bit digital sample which occurs on conductors 62A.

The A/D converter 63 samples the analog signal AL1 on the input port 51 at a rate of 44.1(10³) samples per second, and converts each sample to a sixteen bit digital sample which occurs on conductors 63A. Similarly, the A/D converter 64 samples the analog signal AR1 on the input port 51 at a rate of 44.1(10³) samples per second, and converts each sample to a sixteen bit digital sample which occurs on conductors 64A.

Component 65 is a write buffer which temporarily stores the digital samples that occur on the conductors 60A-64A. These samples are stored in synchronization with a CLOCK signal that is received on an input 65A from the control module 55. Each time the write buffer 65 stores a digital sample from one of the A/D converters 60-64, it signals that A/D converter on conductors 65B to take another sample.

Component 66 is a disc controller, and component 67 is a disc which is controlled by the disc controller 66. The disc controller 66 operates in response to control signals that are received on an input 66A from the control module 55. Write control signals on input 66A direct the disc controller 66 to perform a disc write operation by which samples are sent from the write buffer 65 to the disc 67. Also, read control signals on input 66A direct the disc controller 66 to perform a disc read operation by which samples are sent from the disc 67 to component 80, which is a read buffer.

During a disc write operation, the disc controller 66 repeatedly takes a group of samples from the write buffer 65 on conductors 65C, and sends those samples to the disc 67 in a serial bit stream on conductor 66C. Each time the disc controller 66 takes a group of samples from the write buffer 65, it signals the write buffer on conductors 66B to send another group of samples to the conductors 65C.

To write the samples in a serial bit stream onto the disc 67, the disc controller 66 and the disc 67 interact with each other by control signals on the conductors 66D. These control signals on the conductors 66D can, for example, conform to a standard called “SCSI”, or a standard called “fiber channel”.

One condition which terminates the disc write operation is that the total number of samples in the write buffer 65 has dropped below a predetermined number N1. This condition is indicated by a signal which the write buffer 65 sends to the disc controller 66 on the conductors 66B.

During a disc read operation, the disc controller 66 receives a serial bit stream of samples on conductor 66E from the disc 67, and sends those samples in groups on conductors 66F to the read buffer 80. Each time the disc controller 66 has a group of samples for the read buffer 80, it signals the read buffer 80 on conductor 66G to store the group of samples. Here again, to read the samples in a serial bit stream from the disc 67, the disc 67 and the disc controller 66 interact with each other by control signals on the conductors 66D.

One condition which terminates the disc read operation is that empty storage space in the read buffer has dropped below a predetermined number N3. This condition is indicated by a signal which the read buffer 80 sends to the disc controller 66 on the conductors 66G.

Components 70-74 are A/D converters which operate just like the A/D converter 60-64. The A/D converters 70-74 sample the analog signals Y2-AR2 and convert those samples into digital signals. Items 70A-74A on the A/D converters correspond to items 60A-64A on the A/D converters 60-64.

Similarly, component 75 is a write buffer which operates just like the write buffer 65. The write buffer 75 temporarily stores the digital samples that are generated by the A/D converters 70-74. Items 75A-75C on the write buffer 75 correspond to items 65A-65C on the write buffer 65.

Likewise, component 76 is a disc controller and component 77 is a disc, which respectively operate just like the disc controller 66 and the disc 67. The disc controller 77 performs a disc write operation by which samples are sent from the write buffer 75 to the disc 77, and performs a disc read operation by which samples are sent from the disc 67 to the read buffer 80. Items 76A-76G on the disc controller 76 correspond to items 66A-66G on the disc controller 66.

All of the samples which are stored in the read buffer 80, by the disc controllers 66 and 76, are transferred out of the read buffer on conductors 80A-80E. Samples of Y1 and Y2 are sent on conductors 80A. Samples of PR1 and PR2 are sent on conductors 80B. Samples of PB1 and PB2 are sent on conductors 80C. Samples of AL1 and AL2 are sent on conductors 80D. Samples of AR1 and AR2 are sent on conductors 80E.

The read buffer 80 sends the above samples on the conductors 80A-80E in synchronization with a CLOCK signal that it receives on an input 80F from the control module 55. The samples on the conductors 80A occur at a rate of 13.5(10⁶) samples per second; the samples on the conductors 80B and 80C occur at a rate of 6.75(10⁶) samples per second; and the samples on the conductors 80D and 80E occur at a rate of 44.1(10³) samples per second.

Components 81-85 are D/A converters which respectively receive the samples on the conductors 80A-80E. The read buffer 80 sends a signal, on the conductors 80G, to each of the D/A converters 81-85 which indicates when each D/A converter should receive another sample. From these samples, the D/A converters 81-85 respectively generate the analog signals Y3-AR3 on the output terminal 53.

The control module 55 in FIG. 9 is comprised of components 90, 91, and 92. Component 90 is a remote control receiver, and components 91-92 are two sequential state machines. The state machine 91 is coupled to the write buffer 65 by conductors 91A, is coupled to the disc controller 66 by conductors 91B, and is coupled to the read buffer by conductors 91C. The state machine 92 is coupled to the write buffer 75 by conductors 92A, and is coupled to the disc controller 76 by conductors 92B.

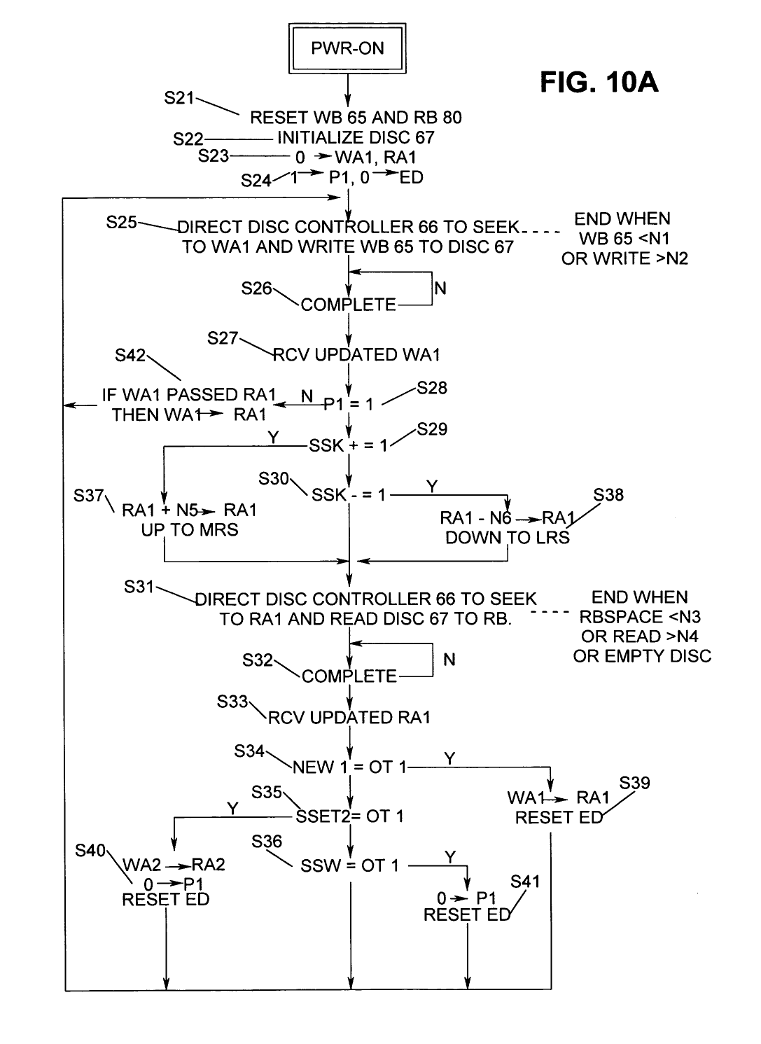

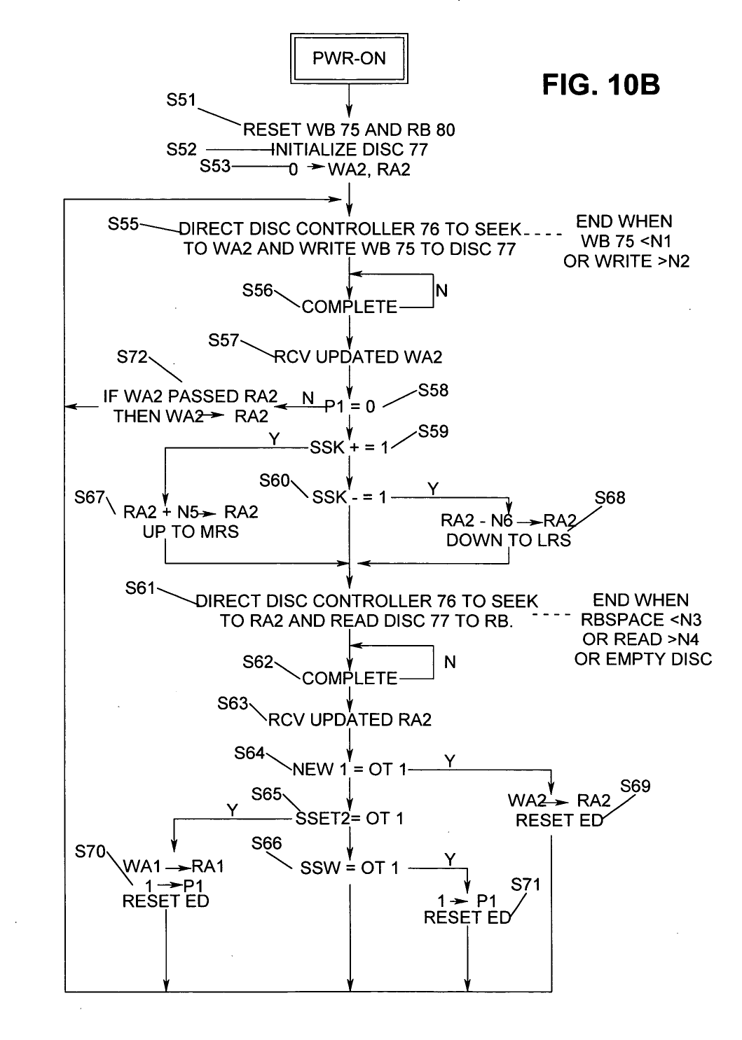

The remote control receiver 90 detects when the following pushbuttons on the handset 58 are being pushed: PWR, SETCH, CH+, CH−, SET2, SW, SK+, and SK−. When the pushing of anyone of those pushbuttons is detected, the remote control receiver 90 sends signals to both of the state machines 91 and 92 on internal conductors, not shown. Then, in response to those signals, the state machines 91 and 92 respectively perform the steps which are shown in FIGS. 10A and 10B.

Next, with reference to FIG. 10A, all of the steps which are performed by state machine 91 will be described. Initially, state machine 91 performs steps S21-S24. This occurs when the electronic device 50 is powered-on.

In step S21, state machine 91 resets the write buffer 65 and the read buffer 80. To do this, state machine 91 sends a control signal to the write buffer 65 on the conductors 91A and to the read buffer 80 on the conductors 91C.

In step S22, state machine 91 initializes the disc 67. To do this, state machine 91 interacts with the disc controller 66 over the conductors 91B. Initializing the disc 67 includes, for example, sending control signals which cause the disc to start rotating, and sensing when the disc is rotating at the proper speed.

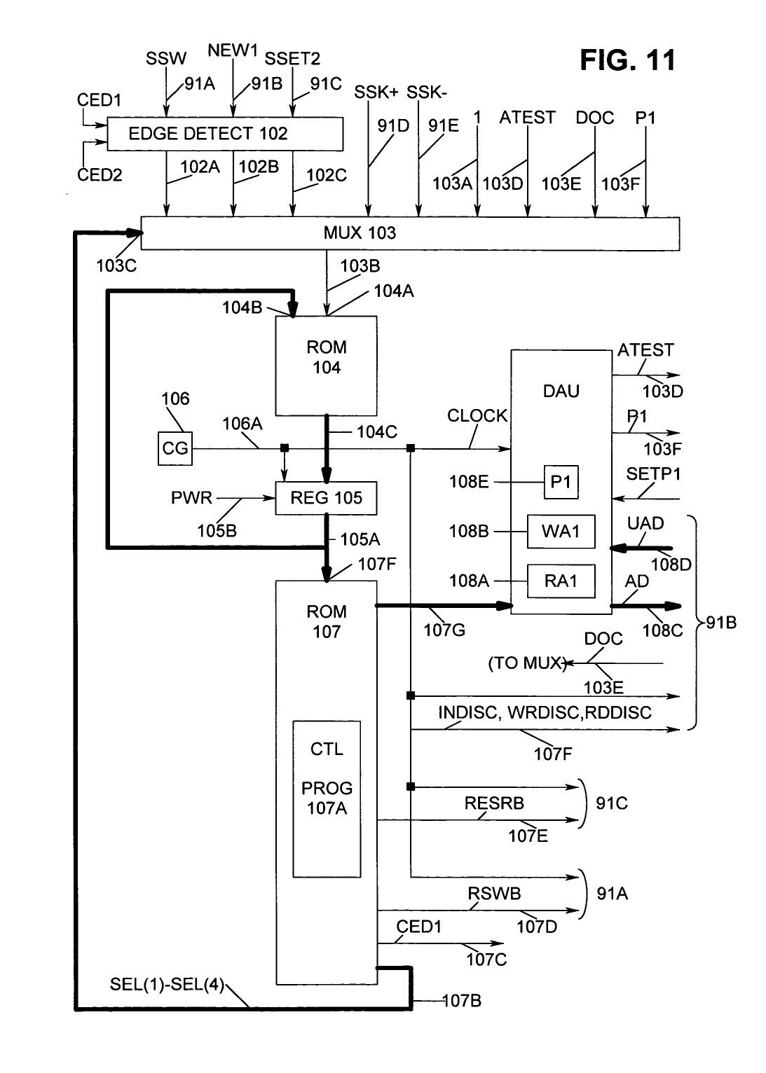

In step S23, state machine 91 clears a write address WA1 and a read address RA1 which are held inside of the state machine 91. WA1 addresses sectors on the disc 67 that are written, and RA1 addresses sectors on the disc 67 that are read. WA1 and RA1 change from zero to NMAX in a sequence that cyclically repeats. These addresses are shown in FIG. 11 which is described later.

In step S24, state machine 91 sets an indictor P1 to a “1”. The indicator P1 is also held inside of the state machine 91, and is shown in FIG. 11. Indicator P1 is a “1” when data samples are to be read from the disc 67 and sent to the read buffer 80. Indicator P1 is a “0” when data samples are to be read from the disc 77 and sent to the read buffer 80.

After the above steps, state machine 91 repeatedly performs steps in a loop. This loop starts with step S25 and can take several different paths back to step S25. One primary path, which follows steps S25-S36, will now be described.

In step S25, state machine 91 directs the disc controller 66 to write samples from the write buffer 65 onto the disc 67. Also in this step, state machine 91 directs the disc controller 66 to start the write at a sector on the disc 67 which has an address that corresponds to address WA1.

In response, the disc controller 66 causes the disc 67 to seek to the sector which has the WA1 address. Then, beginning with that sector, the disc controller 66 writes samples from the write buffer 65 onto the disc 67 until one of the following events occur. First, the disc controller 66 senses, by signals on the conductors 66B, that the number of bytes in the write buffer 65 is less than a predetermined number N1. Second, the disc controller 66 senses by an internal counter that the number of sectors written to the disc 67 in the current operation has exceeded a predetermined number N2.

While the disc controller 66 is performing the above disc write operation, state machine 91 waits in step S26. When the disc write operation ends, the disc controller 66 sends a signal to state machine 91 on the conductors 91B. Then in step S27, state machine 91 takes the updated WA1 address from the disc controller 66 on the conductors 91B. The updated WA1 address equals the address of the sector that was written last, plus one.

After step 27, state machine 91 tests the P1 indicator. This is done in step 28. If P1 is a “1”, then step S29 is performed.

In step S29, state machine 91 tests the signal SSK+. This signal is generated as a “1” by the remote control receiver 90, as long as the SK+ pushbutton is being pushed. If the SSK+ signal is a “0”, then step S30 is performed.

In step S30, state machine 91 tests the signal SSK−. This signal is generated as a “1” by the remote control receiver 90, as long as the SK− pushbutton is being pushed. If the SSK− signal is a “0”, then step S31 is performed.

In step S31, state machine 91 directs the disc controller 66 to read samples from the disc 67 and send then to the read buffer 80. Also in this step, the state machine 91 directs the disc controller 66 to start the read at a sector on disc 67 which has an address that corresponds to address RA1.

In response, the disc controller 66 causes the disc 67 to seek to the sector which has the RA1 address. Then, beginning with that sector, the disc controller 66 reads samples from the disc 67 and sends them to the read buffer 80 until one of the following events occur. First, the disc controller 66 senses, by signals on the conductors 66G, that the total number of bytes of empty storage in the read buffer 80 are less then a predetermined number N3. Second, the disc controller 66 senses by an internal counter that the number of sectors read from the disc 67 in the current operation has exceeded a predetermined number N4. Third, the disc controller senses by an internal comparator that the address of the sector currently being read on the disc 67 equals the address of the sector last written on the disc 67.

While the disc controller 66 is performing the above disc read operation, state machine 91 waits in step S32. When the disc read operation ends, the disc controller 66 sends a signal to state machine 91 on the conductors 91B. Also, the disc controller 66 sends an updated RA1 address to the state machine 91, on the conductors 91B. This updated RA1 address is received by the state machine 91 in step S33, and it equals the address of the sector that was read last, plus one.

Then, in step S34, state machine 91 tests for the occurrence of a “0” to “1” transition in a signal NEW1. This NEW1 signal is generated as a “1” by the remote control receiver 90 as long as one of the pushbuttons SETCH or CH+ or CH− is being pushed. To detect the occurrence of a “0” to “1” transition in NEW1 signal, the state machine 91 includes an edge detector circuit, which will be described later in conjunction with FIG. 11.

If no “0” to “1” transition occurred in the NEW1 signal, then state machine 91 performs step S35. There, state machine 91 tests for a “0” to “1” transition in a signal SSET2. The SSET2 signal is generated as a “1” by the remote control receiver 90 as long as the SET2 pushbutton is being pushed, and the “0” to “1” transition in the SSET2 signal is detected by the above edge detection circuit.

If no “0” to “1” transition occurred in the SSET2 signal, then state machine 91 performs step S36. There, state machine 91 tests for a “0” to “1” transition in a signal SSW. This SSW signal is generated as a “1” by the remote control receiver 90 as long as the SW pushbutton is being pushed, and the “0” to “1” transition in the SSW signal is detected by the above edge detection circuit. If no “0” to “1” transition occurred in the SSW signal, then state machine 91 branches back to the start of the loop at step S25.

Suppose now that back in step S29, the SSK+ signal is a “1”. This means that a portion of the first received TV broadcast, which is currently being read from the disc 67 and sent to the read buffer 80, should be skipped in a forward direction. To achieve this, state machine 91 branches to step S37. There, state machine 91 adds a predetermined number N5 to the read address RA1. Consequently, the portion of the TV broadcast which is on disc 67 between address RA1 and address RA1+N5 will be skipped.

Steps S25-S29, S37, and S31-S36 are repeatedly performed in a loop as long as the SK+ pushbutton is pushed. Each time step S37 is performed, state machine 91 checks to see if RA1+N5 is more than the address of the most recent sector (MRS) which was written on disc 67. If it is, then state machine 91 sets address RA1 to the most recent sector address.

Similarly, suppose that back in step S30, the SSK-signal is a “1”. This means that a portion of the first received TV broadcast, which is currently being read from disc 67 and sent to the read buffer 80, should be skipped in a reverse direction. To achieve this, state machine 91 branches to step S38. There, state machine 91 subtracts a predetermined number N6 from the read address RA1. In order to keep skipping in the reverse direction as long as the SSK− signal is “1”, N6 must be larger than the maximum number of sectors N4 which may be read from the disc 67 in step S31. Also, each time step S38 is performed, state machine 91 checks to see if RA1-N6 is less than the address of the least recent sector (LRS) which was written on the disc 67. If it is, then state machine 91 sets address RA1 to the least recent sector address.

Suppose now that in step S34, state machine 91 senses a “0” to “1” transition in the NEW1 signal. This means that a new channel has been selected by one of the pushbuttons SETCH, CH+, or CH−, for the first TV broadcast which is received. To handle this event, state machine 91 branches to step S39. There, state machine 91 transfers address WA1 into address RA1, resets the edge detector circuit, and branches back to the start of the loop at step S25.

When step S39 is performed, the first TV broadcast in the new channel is just starting to be received as the signals Y1-AR1, and samples of those signals are just starting to be written into the write buffer 65. Samples in the write buffer will be written to the disc 67 beginning at address WA1 the next time step S25 is performed. So by transferring address WA1 into address RA1 in step S39, samples of the newly received TV broadcast will be read from the disc 67 and sent to the read buffer 80 the next time step S31 is performed.

Now suppose that in step S35, state machine 91 senses a “0” to “1” transition in the SSET2 signal. This means that a new channel has been selected, by the SET2 pushbutton, for the second TV broadcast that is received. To handle this event, state machine 91 branches to step S40 where it transfers an address WA2 into an address RA2, resets the indictor P1 to “0”, resets the edge detector circuit, and branches back to the start of the loop at step S25. The addresses WA2 and RA2 are held inside the second state machine 92, and they are used by the second state machine to respectively write data samples to the disc 77 and read data samples from the disc 77.

When step S40 is performed, the second TV broadcast in the channel selected by the SET2 pushbutton is just starting to be received as the signals Y2-AR2, and samples of those signals are just starting to be written into the write buffer 75. Samples in the write buffer 75 will be written to the disc 77 beginning at address WA2. So by transferring address WA2 into address RA2 in step S40 and resetting the indicator P1 to “0”, samples of the newly received second TV broadcast will be read from the disc 77 and sent to the read buffer 80.

Suppose now that in step S36, state machine 91 senses a “0” to “1” transition in the SSW signal. This means that samples of the Y1-AR1 signals need to stop being sent from disc 67 to the read buffer 80, and samples of the Y2-AR2 signals need to start being sent from disc 77 to the read buffer 80. To achieve that, state machine 91 branches to step S41 where it resets the P1 indicator to “0”, resets the edge detector circuit, and branches back to the start of the loop at step S25.

Lastly in FIG. 10A, suppose that in step S28, state machine 91 senses that the P1 indicator is a “0”. This means that samples of the signals Y1-AR1 need to be written on the disc 67, but not read from the disc 67. To achieve that, state machine 91 performs step S42 and then branches back to the start of the loop at step S25.

In step S42, state machine 91 checks to see if the updated write address WA1 from step S27 passed the circuit read address RA1. This many occur when steps S25, S26, S27, S28, and S42 are repeatedly performed in a loop since address WA1 is changing in a cyclic sequence while address RA1 is not changing. If the updated WA1 address passes the RA1 address, then state machine 91 changes address RA1 to address WA1, which is the address if the least recently stored sector on disc 67.

Next, all of the steps which are performed by the second state machine 92 will be described. These steps are shown in FIG. 10B as steps S51-S53 and S55-S72.

The steps S51-S53 and S55-S72 in FIG. 10B are the same as steps S21-S23 and S25-S42 in FIG. 10A, except for the following differences. First, for each step in FIG. 10B that uses WA2 or RA2, the corresponding step in FIG. 10A uses WA1 or RA1, respectively. Second, for each step in FIG. 10B that uses write buffer 75, disc controller 76, or disc 77, the corresponding step in FIG. 10A respectively uses write buffer 65, disc controller 66, or disc 67. Third, for each step in FIG. 10B that sets P1 to a “1”, resets P1 to a “0”, or tests P1 for a “0”, the corresponding step in FIG. 10B respectively resets P1 to a “0”, sets P1 to a “1”, or tests P1 for a “1”.

For example, in step S55 of FIG. 10B, the second state machine 92 directs disc controller 76 to write samples from write buffer 75 onto the disc 77, and to begin this disc write operation at the sector on disc 77 which has address WA2. In the corresponding step S25 of FIG. 10A, the first state machine 91 directs disc controller 66 to write samples from write buffer 65 onto the disc 66, and to begin this disc write operation at the sector on disc 66 which has address WA1.

Similarly, in step S61 of FIG. 10B, the second state machine 92 directs disc controller 76 to read samples from disc 77 beginning at the sector which has address RA2, and to send those samples to the read buffer 80. In the corresponding step S31 of FIG. 10A, the first state machine 91 directs disc controller 66 to read samples from disc 67 beginning at the sector which has address RA1, and to send those samples to the read buffer 80.

State machine 91 performs all of the steps in FIG. 10A while state machine 92 concurrently performs all of the steps in FIG. 10B. Consequently, samples of the signals Y1-AR1 are written onto disc 67, and concurrently, samples of the signals Y2-AR2 are written onto disc 77. Also, concurrently with the above disc write operations, segments of the samples are read from the discs 67 and 77 in an interleaved sequence and sent to the read buffer 80. These segments are read from disc 67 when P1 is a “1”, and are read from disc 77 when P1 is a “0”. The segments that are read from each disc 67 and 77 are spaced-apart and selected as desired by the SW, SK+ AND SK− pushbutton.

Next, with reference to FIG. 11, one preferred structure for the first state machine 91 will be described. This embodiment of state machine 91 includes components 102-108 which are identified below in TABLE 10. All of these components are interconnected as shown in FIG. 11.

TABLE 10

| REF. NUMBER | COMPONENT |
|---|---|
| 102 | Component 102 is an edge detection circuit |
| 103 | Component 103 is a multiplexor circuit |
| 104 | Component 104 is a read-only-memory (ROM) |
| 105 | Component 105 is a register |
| 106 | Component 106 is a clock generator (CG) |
| 107 | Component 107 is a read-only-memory (ROM) |
| 108 | Component 108 is a disc address unit (DAU) |

Inspection of FIG. 11 shows that components 102-108 and their interconnections are similar to those which are shown in FIG. 6 and were previously described. In particular, components 102-108 in FIG. 11 respectively correspond to components 42-48 in FIG. 6.

Conductors 91A-91E in FIG. 11 receive signals from the remote control receiver 90 in FIG. 9, and each signal indicates when a particular pushbutton on the remote control 58 in FIG. 8 is being pushed. Each signal on the conductors 91A-91E is a “1” as long as the corresponding pushbutton is being pushed. The correspondence between the signals on the conductors 91A-91E and the pushbuttons on the remote control 58 is shown below in TABLE 11.

TABLE 11

| SIGNAL | PUSHBUTTON ON REMOTE CONTROL |
|---|---|
| SSW | SW pushbutton |
| SSET2 | SET2 pushbutton |
| NEW1 | Logical “or” of pushbuttons |
| | SETCH, CH+, and CH− |
| SSK+ | SK+ pushbutton |
| SSK− | SK− pushbutton |

In FIG. 11, the signals SSW, NEW1, and SSET2 are sent on the conductors 91A-91C to edge detection circuit 102. This circuit 102 includes three flip-flops (not shown). The first flip-flop is set to a “1” when the SSW signal makes a “0” to “1” transition; the second flip-flop is set to a “1” when the NEW1 signal makes a “0” to “1” transition; etc. Output signals from these three flip-flops occur on conductors 102A-102C. Those flip-flops are cleared to a “0” when either one of two CLEAR EDGE DETECTOR signals CED1 or CED2 is true.

All of the signals on the conductors 102A-102C, and all of the signals on the conductors 91D-91E, are sent to the multiplexor circuit 103. Also, the multiplexor 103 is sent a “1” on conductor 103A and three additional signals on conductors 103D-103F. These three additional signals are described later.

Multiplexor 103 operates to selectively pass one of the signals on the conductors 102A-102C, 91D-91E, 103A, and 103D-103F to its output 103B. This occurs in response to four selection signals SEL(1)-SEL(4) which are sent to control inputs 103C on multiplexor 103.

Output 103B from multiplexor 103 is sent to one address terminal 104A on the ROM 104. Simultaneously, the output signals from register 105 are also sent on conductors 105A to other address terminals 104B on the ROM 104. In response to the signals on both of the address terminals 104A-104B, the ROM 104 generates output signals on conductors 104C. These ROM output signals are stored in register 105 when a “0” to “1” transition occurs in the CLOCK signal which is sent by the clock generator 106 on conductor 106A.

Thus, components 102-106 are the heart of a sequential state machine. The current state of this state machine is held in register 105. The next state of this state machine is stored in ROM 104 and it is read from ROM 104 on conductors 104C in response to the signals on both of the address terminals 104A-104B. The state machine always starts in state zero due to the PWR signal on conductor 105B which clears register 105 when power is turned-on.

All of the output signals from register 105 are also sent on the conductors 105A to address terminals 107F on the ROM 107. A control program 107A is stored within the ROM 107, and one instruction in that control program is read in response to the signals on the address terminals 107F.

Each instruction which is read from the ROM 107 generates six sets of control signals on respective sets of conductors 107B, 107C, 107D, 107E, 107F, and 107G. The control signals on the conductors 107B are SEL(1)-SEL(4) which cause the multiplexor 103 to pass one signal on the conductors 102A-102C, 91D-91E, 103A, and 103D-103F to its output 103B.

The control signal on conductor 107C is CED1. This signal resets the edge detector 102 in steps S24 and S39-S41 of FIG. 10A.

The control signal on conductor 107D is RESWB. This signal resets the write buffer 65 in step S21 of FIG. 10A. The RESWB signal on conductor 107D together with the CLOCK signal on conductor 104C correspond to the signals which are sent in FIG. 9 from state machine 91 to write buffer 65 on conductors 91A.

The control signal on conductor 107E is RESRB. This signal resets the read buffer 80 in step S21 of FIG. 10A. The RESRB signal on conductor 107E together with the CLOCK signal on conductor 104C correspond to the signals which are sent in FIG. 9 from state machine 91 to read buffer 80 on conductors 91C.

The control signals on conductors 107F are INDISC, WRDISC, and RDDISC. The INDISC signal is sent in step S52 of FIG. 10A to direct the disc controller 66 to initialize disc 67. The WRDISC signal is sent in step S55 to direct the disc controller 66 to write samples from write buffer 65 onto the disc 67, beginning with the sector which has address WA1. The RDDISC signal is sent in step S61 to direct the disc controller 66 to read samples from disc 67 beginning with the sector which has address RA1, and to send those samples to the read buffer 80.

The above signals on the conductors 107F, together with four other signals on conductors 106A, 108C, 108D, and 103E, corresponds to the signals which are sent in FIG. 9 between state machine 91 and the disc controller 66 on conductors 91B. On conductor 106A, the CLOCK signal is sent to the disc controller 66. On conductors 108C, the addresses WA1 and RA1 are sent to the disc controller 66. On conductors 108D, the disc controller 66 sends the updated addresses WA1 and RA1 which are received by state machine 91 in steps S27 and S33 of FIG. 10A. On conductor 103E, the disc controller 66 sends DOC signal (DISC OPERTION COMPLETE). This signal is sent to the multiplexor 103 so it can be sensed by state machine 91 in steps S26 and S32 of FIG. 10A.

The only remaining component in FIG. 11 is the disc address unit (DAU) 108. The DAU 108 includes registers 108A and 108B which respectively hold the read address RA1 and the write address WA1 for the disc 67. Various operations and tests are performed on the addresses RA1 and WA1 in the steps of FIG. 10A, and all of those operations and tests occur in the DAU 108 in response to the control signals on the conductors 107G. Each time a particular test is made on address WA1 or RA1, the result is indicated by the ATEST signal on conductor 103D.

The DAU 108 further includes a flip-flop 108E which holds the P1 indictor. In the steps of FIG. 10A, various operations and tests are performed on the P1 indicator, and they also occur in the DAU in response to the control signals on the conductors 107G.

Next, the internal structure of state machine 92 will be described. The internal structure of state machine 92 is the same shown in FIG. 11, except for the following differences.

First, the edge detector circuit 102 in state machine 92 is eliminated, and the output signals from the edge detector circuit 102 in state machine 91 are sent on the conductors 102A-102C to the multiplexor 103 in state machine 92. Similarly, the clock generator 106 in state machine 92 is eliminated, and the CLOCK signal from the clock generator 106 in state machine 91 is sent on conductor 106A to state machine 92.

Second, the signals in FIG. 11 which are labeled 91A and 91B for state machine 91, are respectively relabeled as 92A and 92B for state machine 92. This is consistent with FIG. 9. Similarly, the addresses in FIG. 11 which are label RA1 and WA1 for state machine 91, are respectively relabeled as RA2 and WA2 for state machine 92. This is consistent with FIG. 10B. Likewise, the signal on conductor 107C in FIG. 11, which is labeled CED1 for state machine 91, is relabeled as CED2 for state machine 92. This CED2 signal resets the edge detector in steps S69-S71 of FIG. 10B.

Third, in state machine 102, the FIG. 11 signals which are labeled 91C are deleted. This is consistent with FIG. 9 which shows that state machine 91 sends control signals to the read buffer 80, but state machine 92 does not. Similarly, in state machine 92, the FIG. 11 flip-flop 108E which holds the P1 indicator is eliminated. The P1 indictor in state machine 91 can be tested in state machine 92 on the conductor 103F, and can be set from state machine 92 by the SETP1 signal.

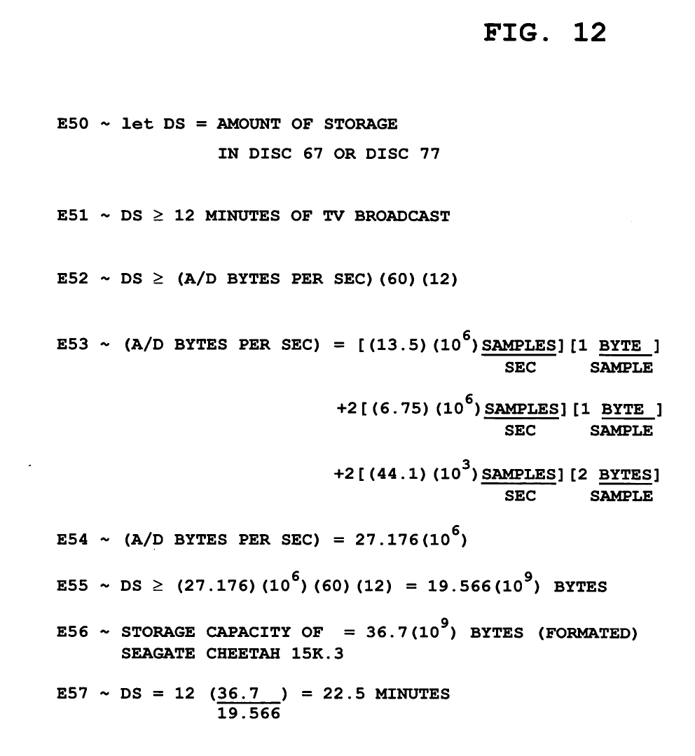

Next, with reference to FIG. 12, additional details will be described regarding each of the discs 67 and 77 in FIG. 9. To begin, equation E50 defines a variable “DS” as the amount of storage that is in each disc 67 or 77. One constraint on the variable DS is that it must be large enough to temporarily store at least twelve minutes of a TV broadcast, and this is stated by equation E51. The constraint of equation E51 comes from the previously described timing diagram of FIG. 3 which directly illustrates the operation of the electronic device 50 in FIG. 8 and its internal components in FIG. 9.

Next, equation E51 is rewritten as equation E52. The term “A/D BYTES PER SEC” in equation E52 is the number of bytes which are generated each second by the A/D converters 60-64 in FIG. 9. The term “60” in equation E52 is simply the number of seconds per minute.

Next, the term “A/D BYTES PER SEC” in equation E52 is expanded into its component parts by equation E53. The first term in equation E53 is due to the samples of the Y1 signal from the A/D converter 60 on FIG. 9. The second term in equation E53 is due to the samples of the PR1 and PB1 signals from the A/D converters 61 and 62 in FIG. 9. The third term in equation E53 is due to the samples of the AL1 and AR1 signals from the A/D converters 63 and 64 in FIG. 9.

Next, equation E54 is obtained by adding all of the terms that are in equation E53. Then, equation E55 is obtained by substituting the right side of equation E54 into the right side of equation E52.

Equation E55 says that each disc 67 and 77 needs 19.566 gigabytes of storage in order to temporarily hold 12 minutes of samples from the A/D converters in FIG. 9. One particular disc that easily meets this constraint is identified by equation E56 as the SEAGATE CHEETAH 15K.3 disc. It has a formatted storage capacity of 36.7 gigabytes, yet its physical size is only 1 inch high, 4 inches wide, and 5.8 inches deep.

When each of the discs 67 and 77 in FIG. 9 is one of the above identified CHEETAH discs, then samples of the Y1-AR1 signals and Y2-AR2 signals can be temporarily stored for 22.5 minutes. This is calculated by equation E57. This storage time of 22.5 minutes is almost twice the minimum requirement as given by equation E51.

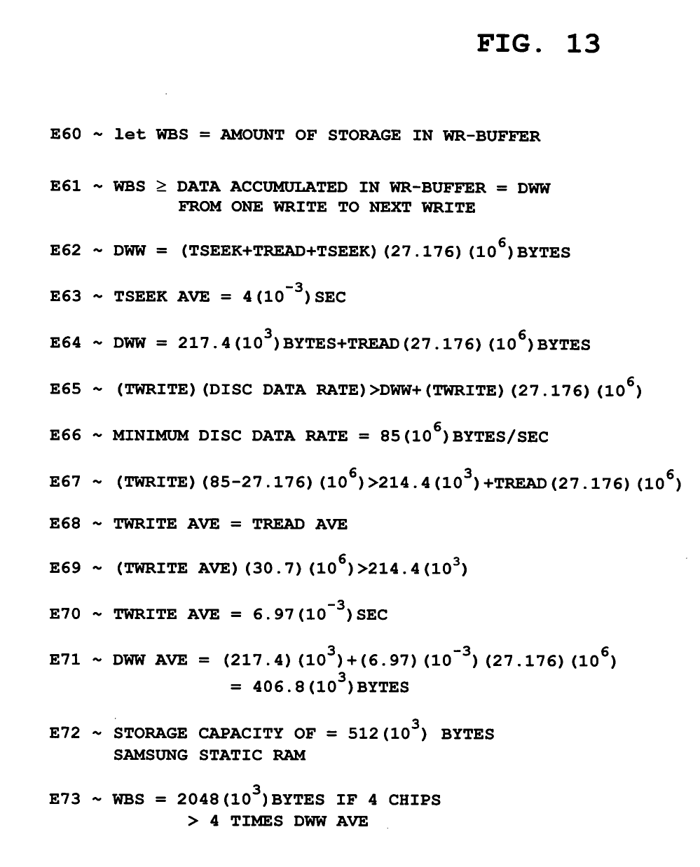

Next, with reference to FIG. 13, additional details will be described regarding each of the write buffers 65 and 75 in FIG. 9. To begin, equation E60 defines a variable WBS (write buffer storage) as the number of bytes that can be stored in each write buffer 65 and 75. One constraint on WBS is that it must be large enough to temporarily store all of the samples that are generated by the A/D converters 60-64 during the time that passes from the end of one disc write operation to the start of the next disc write operation. This constraint is stated by equation E61.

Each of the above disc write operations occur in step S25 of FIG. 10A. The total number of bytes that are generated by the A/D converters 60-64 from the end of one disc write to the start of the next disc write is defined in equation E61 as DWW (disc write-to-write).

Next, in equation E62, the term DWW is expanded into its component parts. The component TSEEK is the time which disc 67 or 77 take during a seek. The component TREAD is the time which disc 67 or 77 take during a read. The component 27,176,000 is the number of bytes which are generated each second by the A/D converters 60-64. This was previously calculated by equation E54 in FIG. 12.

Next, in equation E63, an average value for TSEEK is set to 4.0 milliseconds. By comparison, the specifications on the previously identified CHEETAH disc give an average read seek time of 3.5 milliseconds, and an average write seek time of 4.0 milliseconds. Equation E64 is obtained by substituting 4.0 milliseconds from equation E63 for each TSEEK in equation E62.

Next, equation E65 states another constraint that must be met by each write buffer 65 and 75. The left side of equation E65 is the total number of bytes that are taken out of write buffer 65 or 75 during a disc write operation. The right side of equation E65 is the total number of bytes that are sent to write buffer 65 or 75 from the end of one disc write operation to the end of the next disc write operation. By meeting the constraint of equation E65, the write buffer 65 or 75 will be emptied each time a write operation is respectively performed on disc 67 or 77.

In equation E65 the “DISC DATA RATE” increases as the rotating speed of the disc increase and as the radius of the track being written on the disc increases. For the previously identified CHEETAH disc, the DISC DATA RATE has a minimum value of 85 megabytes per second, and a maximum value of 142 megabytes per second.

The above minimum DISC DATA RATE is stated by equation E66. Then, equation E67 is obtained by substituting the right side of equation E66 into the left side of equation 65, and rearranging the resulting terms.

Next, equation E68 states that, on average, TWRITE for disc 67 or 77 will equal TREAD. Meeting this constraint prevents the disc write operations from gradually filling up disc 67 or 77 over a long period of time, and prevents the disc read operations from gradually emptying those discs over a long period of time.

Utilizing the above constraint, equation E69 is obtained by changing TREAD to TWRITE in equation E67 and rearranging the resulting terms. Then, equation E70 is obtained by solving equation E69 for TWRITE AVE.

TWRITE AVE as determined by equation E70 is 6.97 milliseconds. This also equals TREAD AVE due to equation E68. Thus, by substituting 6.97 milliseconds for TREAD into equation E64, the value for DWW is obtained. This is done in equation E71 where DWW is calculated to be 406,800 bytes.

One particular memory chip which easily provides the above 406,800 bytes of storage is identified in equation E72 as the 256KX16 static RAM chip from Samsung Corporation. This static RAM chip has 256,000 words of storage of two bytes per word. Also, this static RAM chip has a cycle time of only ten-nanoseconds and requires no refresh cycles.

Several of the above identified static RAM chips can be incorporated into each write buffer 66 and 77, as desired. For example, equation E73 shows that if each write buffer 66 and 77 includes four of the above static RAM chips, then each write buffer will have more than two-million bytes of storage, or more than four times DWW AVE.

Also, by arranging the above four static RAM chips in parallel, eight bytes can be written to or read from these chips in a single cycle of ten-nanoseconds. These eight bytes could include four samples of Y1 (or Y2), two samples of PR1 (or PR2), and two samples of PB1 (or PB2). These eight bytes could also include two samples of AL1 (or AL2) and two samples of AR1 (or AR2).

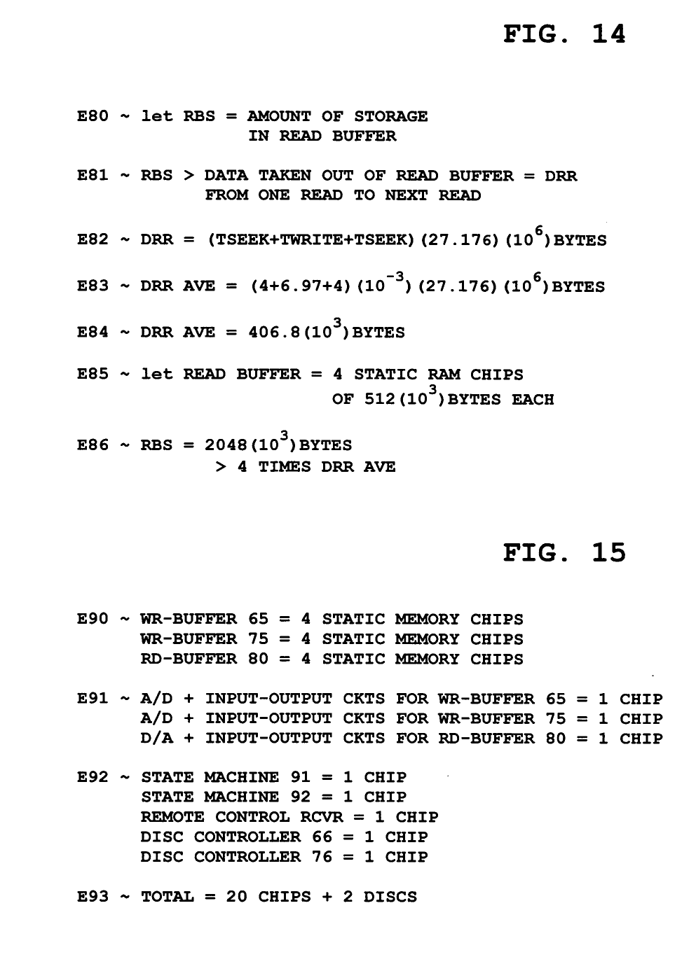

Next, with reference to FIG. 14, additional details will be described regarding the read buffer 80 in FIG. 9. To begin, equation E80 defines a variable RBS (read buffer storage) as the number of bytes that can be stored in the read buffer 80. One constraint on RBS is that it must be large enough to temporarily store all of the samples that are sent to the D/A converters 81-85 during the time that passes from the end of one disc read operation to the start of the next disc read operation. This constraint is stated by equation E81.

The above disc read operations occur in step S31 of FIG. 10A and step S61 in FIG. 10B. The total number of bytes that are sent to the D/A converters 81-85 from the end of one disc read to the start of the next disc read is defined in equation E81 as DRR (disc read-to-read).

Next, in equation E82, the term DRR is expanded into its component parts. The component TSEEK is the time which disc 67 or 77 take during a seek. The component TWRITE is the time which disc 67 or 77 take during a write. The component 27,176,000 is the number of bytes which are sent in each second to the D/A converters 81-85. This number equals the number previously calculated by equation E54 in FIG. 12.

Each of the terms TSEEK and TWRITE in equation E82 has an average value that was previously determined. TSEEK AVE is given by equation E63 as 4 milliseconds, and TWRITE AVE is given by equation E70 as 6.97 milliseconds. Substituting these values into equation E82 yields equation E83. Then, doing the multiplication and addition in equation E83 yields equation E84 which says DRR AVE equals 406,800 bytes.

The above storage requirement for read buffer 80 can be met by the same static RAM chip that was previously identified for the write buffers 65 and 75. Here again, four of these static RAM chips can be incorporated into the read buffer 80, in parallel. Then the total storage capacity of the read buffer 80 will be more than four times the required DRR AVE. This is stated by equations E85 and E86. Also, eight bytes of samples can be written to or read from these four static RAM chips in a single ten-nanosecond cycle.

Next, with reference to FIG. 15, the total number of IC-chips in the entire electronic device 50 of FIGS. 8 and 9 will be determined. To begin, the equations E90 state that write buffer 65 includes four static RAM chips; write buffer 75 includes four static RAM chips; and read buffer 80 includes four static RAM chips.

Associated with the four static memory chips in write buffer 65 are the A/D converters 60-64, and support circuitry which is inside of the write buffer. This support circuitry is conventional for a write buffer and consists of—a) input registers that transfer samples from the conductors 60A-64A to the static RAM chips, b) output registers that transfer samples from the static RAM chips to the disc controller 66, and c) timing circuits for these registers and the static RAM chips.

All of the above circuits which are associated with write buffer 65 can easily be implemented in a single IC-chip. Likewise, the same circuits for write buffer 75 can be implemented in a second IC-chip; and similar circuits for read buffer 80 can be implemented in a third IC-chip. These three IC-chips are identified by equation E91.

The remaining circuit modules in FIG. 9 are the two disc controllers 66 and 76, the two state machines 91 and 92, and the remote control receiver 90. Each of these circuit modules can be implemented with a corresponding IC-chip. This is stated by equation E92.

From the above equations E90-E92 it follows that the entire electronic device 50 of FIGS. 8 and 9 can be built with only twenty IC-chips and two discs. This result is stated by equation E93. Also, the result in equation E93 is based on current IC-chip technology. The amount of circuitry which can be incorporated into a single IC-chip has greatly increased in the past, so the twenty IC-chips in equation E83 could easily be cut in half as IC-chip technology advances.

Two preferred embodiments of the present invention have now been described in detail. Next, several modifications to those embodiments will be described.

The first modification relates back to FIG. 1. There, the electronic device 10 is shown as a rectangular box in order to simplify the drawing. However, as one modification, the electronic device 10 can be changed to have a decorative front and a shape that is suitable for mounting in the dashboard of a car or a truck. As another modification, the electronic device 10 can have a decorative overall look that is suitable for use in a home.

The second modification relates back to FIG. 2. There, the signals RS1 and RS2 are analog signals which will reproduce sound in two received radio broadcasts if they are sent through separate audio amplifiers to respective speakers. However, as one modification, the received radio broadcasts can be in stereo. In that case, the first radio receiver 21 will produce two analog signals instead of the RS1 signal, and the second radio receiver will produce two analog signals instead of the RS2 signal. To process these four analog signals, submodule 30 in FIG. 2 is simply duplicated.

The third modification relates to both FIG. 2 and FIG. 9. Beginning with FIG. 2, it includes A/D converters 32A and 32B, which were previously described as sampling the analog signals RS1 and RS2 at a rate of 44,100 samples per second, and converting each analog sample to a sixteen bit digital sample. However, as a modification, the sampling rate of the A/D converters 32A and 32B can be changed to any rate which enables the program segments in the RS1 and RS2 signals to be regenerated from their samples. Likewise, the number of bits that are generated for each digital sample can be changed to any number which enables the program segments in the RS1 and RS2 signals to be regenerated from their samples. Similarly, in FIG. 9, the previously described sampling rates of the A/D converters 60-64 and 70-74 can be changed, and the previously described number of bits in each digital sample can be changed.

The fourth modification relates to both FIG. 6 and FIG. 11. Beginning with FIG. 6, there the signals SK+ and SK− are shown as going directly to the multiplexor 43 and bypassing the edge detector 42. This enables the state machine 43-46 to skip continuously as long as the SK+ signal or SK− signal is true. However, as a modification, the SK+ and SK− signals can be sent to the edge detector 42. Then, the state machine 43-46 would detect “0” to “1” transitions in the SK+ and SK− signals, and in response skip program breaks by a predetermined amount. Similarly, in FIG. 11, the signals SSK+ and SSK− can be sent to the edge detector 102. Then, state machine 103-106 would skip program breaks by a predetermined amount in response to each “0” to “1” transition of the signals SSK+ and SSK−.

The fifth modification relates to FIG. 9. There, digital samples from the A/D converters 60-64 and 70-74 are unaltered before they are stored on the discs 67 and 77. However, as a modification, the digital samples from the A/D converters 60-64 and 70-74 can be compressed and then stored on the discs. In that case, one data compression module would be interposed between the A/D converters 60-64 and write buffer 65; another data comparison module would be interposed between the A/D converters 70-74 and write buffer 75; and a data decompression module would be interposed between read buffer 80 and the D/A converters 81-85. Similarly, error correction circuitry can also be interposed in the same manner.

The sixth modification also relates to FIG. 9. There, the analog signals which are sent to the A/D converters 60-62 and 70-72 are the component video signals Y1-PB1 and Y2-PB2. However, as a modification, one standard composite video signal can be sent to a single A/D converter in place of the three component video signals Y1-PB1, and another composite video signal can be sent to a single A/D converter in place of the three component video signals Y2-PB2. Then, the three D/A converters 81-83 would be replaced by a single D/A converter which generates one composite video output signal.

The seventh modification relates to both FIG. 1 and FIG. 8. In FIG. 1, the SET2 pushbutton is pushed to receive the second radio broadcast from the same carrier frequency that was last selected for the first radio broadcast. However, as a modification, the SET2 pushbutton in FIG. 1 can be replaced with a slider switch that has two positions. When this slider switch is in one position, the pushbuttons 12B-12J would select the first radio broadcast, and when this slider switch is in the other position, the pushbuttons 12B-12J would select the second radio broadcast. Likewise, in FIG. 8, the SET2 could be replaced with a two-position slider switch that operates in a similar fashion.

The eighth modification also relates to both FIG. 1 and FIG. 8. There, two pushbuttons are provided which send the SWITCH and SKIP commands to the operator interface in the control module. However, as a modification, those two pushbuttons can be replaced with a circuit that sends the SWITCH and SKIP commands in a hands-free manner. Such a circuit would include a miniature microphone which has an output that is connected to first and second detectors that each detect a particular word or sound. The first detector would send the SWITCH command, and the second detector would send the SKIP command, when they detect their respective word or sound.

The ninth modification relates to FIG. 1. There, several of the pushbuttons that are shown can be eliminated in order to simplify the electronic device 10 and thereby make it more portable. For example, all of the preset pushbuttons PS1-PS6 can be eliminated. Also, the ability to skip backward can be eliminated by changing the −SKIP+ pushbutton to just a SKIP pushbutton.

The tenth modification also relates to FIG. 1. There, all of the pushbuttons 12A-12N are on a control panel 11 which is attached to the electronic device 10. However, as a modification, the pushbuttons 12A-12N can be on a remote control handset, just like the handset 58 that is shown in FIG. 8. With this modification, the control module for the electronic device 10 that is shown in FIG. 6 would include a remote control receiver, just like the receiver 90 in FIG. 9.

In view of these modifications and others which are obvious from the hindsight that is acquired from the detailed description of the preferred embodiments, it is to be understood that the scope of the present invention is not limited to just the details of the preferred embodiments but is defined by the following claims.

What is claimed is:

1. An electronic device which is comprised of:
a memory means and a control circuit means that is coupled to said memory means;
said control circuit means including means for repeatedly performing three operations which are—a) storing samples of a first received broadcast within said memory means in a first sequence, b) storing samples of a second received broadcast within said memory means in a second sequence, and c) sending the stored samples from said memory means to an output port in a third sequence, where said third sequence consists essentially of selectable spaced-apart segments of said first sequence that are interleaved with selectable spaced-apart segments of said second sequence; and,
an operator interface means, coupled to said control circuit means, for selecting said spaced-apart segments of said first and second sequences.

2. An electronic device according to claim 1 wherein said control circuit means further includes an addressing means for generating—a) a first write address which addresses a storage location in said memory means for a current sample in said first sequence, b) a second write address which addresses a storage location in said memory means for a current sample in said second sequence, and c) first and second read addresses which address separate storage locations in said memory means of current samples for said third sequence that respectively come from said first and second sequences.

3. An electronic device according to claim 2 wherein said addressing means generates said first write address, said second write address, said first read address, and said second read address as a cyclic series of addresses.

4. An electronic device according to claim 3 wherein said addressing means—a) stops said first read address from passing said first write address in said cyclic series, and b) stops said second read address from passing said second write address in said cyclic series.

5. An electronic device according to claim 3 wherein said addressing means—a) changes said first read address to an address of a least recent sample within said first sequence in said memory means if said first write address passes said first read address in said cyclic series, and b) changes said second read address to an address of a least recent sample within said second sequence in said memory means if said second write address passes said second read address in said cyclic series.

6. An electronic device according to claim 1 wherein said control circuit means operates cyclically in a timed loop of predetermined duration where in each timed loop, said control circuit means stores a single sample of said first sequence within said memory means, stores a single sample of said second sequence within said memory means, and sends a single sample from said memory means to said output port as long as one of said selectable segments is currently selected.

7. An electronic device according to claim 1 wherein said control circuit means is comprised of a single state machine.

8. An electronic device according to claim 1 wherein said control circuit means is comprised of a first state machine and a second state machine that operates concurrently with said first state machine.

9. An electronic device according to claim 1 wherein said memory means includes one dynamic memory chip which stores all of said samples of said first sequence and another dynamic memory chip which stores all of said samples of said second sequence.

10. An electronic device according to claim 1 wherein said memory means includes two dynamic memory chips which store all of said samples of said first sequence and two other dynamic memory chips which store all of said samples of said second sequence.

11. An electronic device according to claim 1 wherein said memory means includes a first disc which stores all of said samples of said first sequence, and a second disc which stores all of said samples of said second sequence.

12. An electronic device according to claim 11 wherein said memory means includes a first write buffer for said first disc, a second write butter for said second disc, and a single read buffer that is shared by said first and second discs.

13. An electronic device according to claim 1 wherein said operator interface means includes a means for receiving a SWITCH command and at least one SKIP command, and said control circuit means—a) sends samples of said first sequence to said output port if samples of said second sequence are being sent when a leading edge of said SWITCH command is received, and vice-versa; and b) addresses said samples in said memory means for said third sequence such that said addresses change by a predetermined amount per unit of time if said SKIP command is not being received, and otherwise changes by a larger amount per unit of time.

14. An electronic device according to claim 1 wherein said operator interface means includes a means for receiving commands, over electrical conductors from a control panel, which select said spaced-apart segments of said first and second sequences.

15. An electronic device according to claim 1 wherein said operator interface means includes a means for receiving commands, by wireless transmission from a remote control handset, which select said spaced-apart segments of said first and second sequences.

16. An electronic device according to claim 1 and further including a broadcast receiving means, coupled to said memory means, for receiving two radio broadcasts simultaneously in separate frequency bands and generating first and second analog signals that respectively represent said first received broadcast and said second received broadcast.

17. An electronic device according to claim 1 and further including a broadcast receiving means, coupled to said memory means, for receiving two television broadcast simultaneously in separate channels and generating first and second sets of analog signals that respectively represent said first received broadcast and said second received broadcast.

18. An electronic device which is comprised of:
a memory means and a control circuit means that is coupled to said memory means;
said control circuit means including means for repeatedly—a) storing first signals in said memory means that represent a first received broadcast, b) storing second signals in said memory means that represent a second received broadcast, and c) generating an output signal which consists essentially of selectable spaced-apart segments of said first signals from said memory means that are interleaved with selectable spaced-apart segments of said second signals from said memory means; and,
an operator interface means, coupled to said control circuit means, for selecting said spaced-apart segments of said first and second signals.
